(19) United States
(12) Patent Application Publication
(10) Pub. No.: US 2025/0348368 A1
(43) Pub. Date: Nov. 13, 2025

(54) OVERLAY APPLICATION AND TECHNIQUES FOR INTERFACING WITH A GENERATIVE RESPONSE ENGINE

(71) Applicant: OpenAI OpCo, LLC, San Francisco, CA (US)

(72) Inventors: Benjamin Newhouse, San Francisco, CA (US); Yash Kumar, San Francisco, CA (US); Patrik Goethe, San Francisco, CA (US)

(73) Assignee: OpenAI OpCo, LLC, San Francisco, CA (US)

(21) Appl. No.: 18/773,832

(22) Filed: Jul. 16, 2024

Related U.S. Application Data
(60) Provisional application No. 63/645,438, filed on May 10, 2024.

(51) Int. Cl. G06F 9/54; G06F 9/451

(52) U.S. Cl. CPC G06F 9/542; G06F 9/451

(57) ABSTRACT

The present technology provides an interaction paradigm whereby an overlay application can interface with a local device and a generative response engine in a seamless manner and can increase the surface area by which a person can engage generative response engines. In addition, the interface can allow the generative response engine a larger understanding of the user's context of the question, and can thereby enable a more detailed understanding of the prompt and provide a more detailed and accurate response. The overlay application may include various mechanisms to interface with the local applications, such as by employing a dynamic interface that selectively displays context of prompts to the user without being intrusive. The overlay application can be configured to control aspects of the user interface, such as providing mouse and keyboard input events, to generically control different user interfaces based on computer vision techniques.

### CROSS-REFERENCE TO RELATED APPLICATIONS

This application claims the benefit of U.S. provisional application No. 63/645,438, filed on May 10, 2024, entitled OVERLAY APPLICATION AND TECHNIQUES FOR INTERFACING WITH A GENERATIVE RESPONSE ENGINE, which is expressly incorporated by reference herein in its entirety.

### TECHNICAL FIELD

The disclosure relates generally to generative response engines and, more an overlay application and techniques for interfacing with a generative response engine.

### BACKGROUND

Generative response engines often provide a conversational interface wherein a user can provide a prompt (usually text in natural language, which can optionally be combined with one or more images or files) to the generative response engine, and the generative response engine provides a response (also generally in natural language, which can optionally be combined with images, code, applications, etc. that are responsive to the prompt).

### BRIEF DESCRIPTION OF THE DRAWINGS

Details of one or more embodiments of the subject matter described in this disclosure are set forth in the accompanying drawings and the description below. However, the accompanying drawings illustrate only some typical embodiments of this disclosure and are therefore not to be considered limiting of its scope. Other features, embodiments, and advantages will become apparent from the description, the drawings and the claims:

FIG. 1 is a block diagram illustrating an exemplary machine learning platform for implementing various aspects of this disclosure in accordance with some embodiments of the present technology;

FIG. 2 is a conceptual block diagram of an operator in accordance with some embodiments of the present technology;

FIG. 3 illustrates a method performed by an operator in accordance with some embodiments of the present technology;

FIG. 4 is a conceptual diagram of an operator including a translucent overlay in accordance with some embodiments of the present technology;

FIGS. 5A-5G are conceptual illustrations of a translucent overlay of the operator in accordance with some embodiments of the present technology;

FIG. 6 illustrates a conceptual diagram of an application that is configured to generate training data in accordance with some embodiments of the present technology;

FIGS. 7A and 7B illustrate conceptual examples of a pair of screenshots captured by a training application as part of a timestep in accordance with some embodiments of the present technology;

FIG. 8 illustrates an example method for generating an input in a user interface of an application by a generative response engine in accordance with some embodiments of the present technology;

FIG. 9 illustrates an example method for generating an input in a user interface of an application by a generative response engine in accordance with some embodiments of the present technology;

FIG. 10 illustrates an example method for generating an input in a user interface of application based on a response from a generative response engine in accordance with some embodiments of the present technology

FIG. 11 illustrates an example method for generating an input in a user interface of application by a generative response engine in accordance with some embodiments of the present technology;

FIG. 12 illustrates an example method for preventing the generative response engine from taking an action in accordance with some embodiments of the present technology;

FIG. 13 illustrates an example method for supplementing prompts to guide a generative response engine to a safe response in accordance with some embodiments of the present technology;

FIG. 14 illustrates a conceptual diagram of an optical interface engine in accordance with some embodiments of the present technology;

FIG. 15 illustrates a conceptual diagram of an application that is configured to generate training data in accordance with some embodiments of the present technology;

FIG. 16 is a conceptual illustration of an observation space of a generate response engine in accordance with some embodiments of the present technology;

FIGS. 17A-17D are conceptual diagrams that illustrate another campaign that is being performed by a supervised generative response engine in accordance with some embodiments of the present technology;

FIGS. 18A-18B illustrate operation of an input discriminator to improve input generated by a generative response engine in accordance with some embodiments of the present technology;

FIGS. 18C-18D illustrate operation of a safety discriminator for ensuring safe operation of a generative response engine in accordance with some embodiments of the present technology;

FIG. 19 illustrates an example method for generating data for training a generative response engine in accordance with some embodiments of the present technology;

FIG. 20 illustrates an example method for controlling a remove device based on a task provided to a generative response engine in accordance with some embodiments of the present technology in accordance with some embodiments of the present technology;

FIG. 21 illustrates an example method for controlling a remote device based on a task provided to a generative response engine in accordance with some embodiments of the present technology; and

FIG. 22 illustrates an example method for preventing unsafe or non-permitted tasks using a safety model in accordance with some embodiments of the present technology;

FIG. 23 is a block diagram of an example transformer in accordance with some aspects of the disclosure; and

FIG. 24 shows an example of a computing system, which may be for example any computing device that may implement components of the system.

### DESCRIPTION

Generative response engines often provide a conversational interface wherein a user can provide a prompt (usually text in natural language, which can optionally be combined with one or more images or files) to the generative response engine, and the generative response engine provides a response (also generally in natural language, which can optionally be combined with images, code, applications, etc. that are responsive to the prompt). However, generative response engines are configured to interact via text and are also limited in their ability to interface with a system due to a browser sandbox environment.

These limitations reduce the ability of a generative response engine to meaningfully engage with common tasks that are repetitive or require specialized knowledge that is infrequently used. Generative response engines have the ability to engage and perform relevant tasks in many different contexts, such as writing content, writing code, generating markup, and so forth. The inability of a generative response engine to directly interface with a person's working environment because of the browser sandbox limits prevents the generative response engine from being able to apply its content generation and language understanding abilities to carry out more sophisticated tasks or transactions on behalf of a user.

Additionally, when users attempt to utilize generative response engines for more sophisticated tasks or transactions, the user plays the role of an intermediary between the operating environment in which the task or transaction is conducted and the interface of the generative response engine. This indirect interface also increases the surface area for errors to be introduced, particularly because the user might not convey sufficient details regarding the operating environment in which the task is taking place, and therefore, the generative response engine may not have the full context in the human-provided prompt.

The present technology addresses these challenges by providing an interaction paradigm whereby an overlay application can interface with a local device and a generative response engine in a seamless manner and can increase the surface area by which a person can engage generative response engines. In addition, the interface can allow the generative response engine a larger understanding of the user's context of the question, and can thereby enable a more detailed understanding of the prompt and provide a more detailed and accurate response.

The overlay application may include various mechanisms to interface with the local applications, such as by employing a dynamic interface that selectively displays the context of prompts to the user without being intrusive. The overlay application can be configured to control aspects of the user interface, such as providing mouse and keyboard input events, to generically control different user interfaces based on computer vision techniques. The overlay can also interface with other applications using different surfaces, such as an application programming interface (API) or via a document object model (DOM).

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

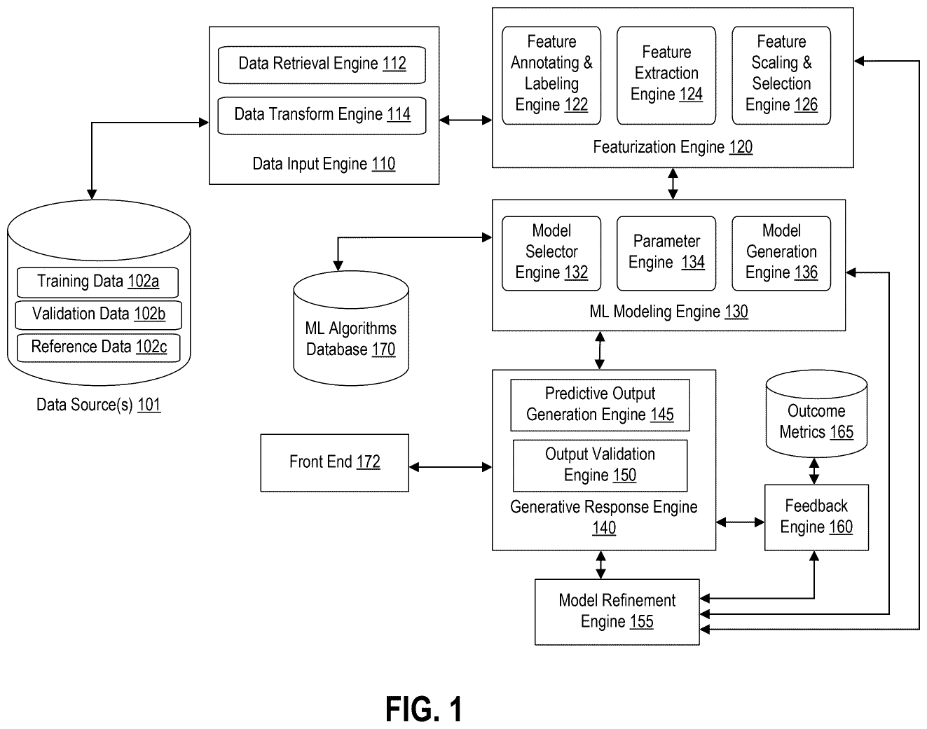

FIG. 1 is a block diagram illustrating an example machine learning platform for implementing various aspects of this disclosure in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

System 100 may include data input engine 110 that can further include data retrieval engine 112 and data transform engine 114. Data retrieval engine 112 may be configured to access, interpret, request, or receive data, which may be adjusted, reformatted, or changed (e.g., to be interpretable by another engine, such as data input engine 110). For example, data retrieval engine 112 may request data from a remote source using an API. Data input engine 110 may be configured to access, interpret, request, format, re-format, or receive input data from data source(s) 101. For example, data input engine 110 may be configured to use data transform engine 114 to execute a re-configuration or other change to data, such as a data dimension reduction. In some embodiments, data source(s) 101 may be associated with a single entity (e.g., organization) or with multiple entities. Data source(s) 101 may include one or more of training data 102a (e.g., input data to feed a machine learning model as part of one or more training processes), validation data 102b (e.g., data against which at least one processor may compare model output with, such as to determine model output quality), and/or reference data 102c. In some embodiments, data input engine 110 can be implemented using at least one computing device. For example, data from data source(s) 101 can be obtained through one or more I/O devices and/or network interfaces. Further, the data may be stored (e.g., during execution of one or more operations) in a suitable storage or system memory. Data input engine 110 may also be configured to interact with a data storage, which may be implemented on a computing device that stores data in storage or system memory.

System 100 may include featurization engine 120. Featurization engine 120 may include feature annotating & labeling engine 122 (e.g., configured to annotate or label features from a model or data, which may be extracted by feature extraction engine 124), feature extraction engine 124 (e.g., configured to extract one or more features from a model or data), and/or feature scaling & selection engine 126 Feature scaling & selection engine 126 may be configured to determine, select, limit, constrain, concatenate, or define features (e.g., artificial intelligence (AI) features) for use with AI models.

System 100 may also include machine learning (ML) modeling engine 130, which may be configured to execute one or more operations on a machine learning model (e.g., model training, model re-configuration, model validation, model testing), such as those described in the processes described herein. For example, ML modeling engine 130 may execute an operation to train a machine learning model, such as adding, removing, or modifying a model parameter. Training of a machine learning model may be supervised, semi-supervised, or unsupervised. In some embodiments, training of a machine learning model may include multiple epochs, or passes of data (e.g., training data 102a) through a machine learning model process (e.g., a training process). In some embodiments, different epochs may have different degrees of supervision (e.g., supervised, semi-supervised, or unsupervised). Data into a model to train the model may include input data (e.g., as described above) and/or data previously output from a model (e.g., forming a recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. The combination and configuration of the model parameters and relationships between model parameters discussed herein are cognitively infeasible for the human mind to maintain or use. Without limiting the disclosed embodiments in any way, a machine learning model may include millions, billions, or even trillions of model parameters. ML modeling engine 130 may include model selector engine 132 (e.g., configured to select a model from among a plurality of models, such as based on input data), parameter engine 134 (e.g., configured to add, remove, and/or change one or more parameters of a model), and/or model generation engine 136 (e.g., configured to generate one or more machine learning models, such as according to model input data, model output data, comparison data, and/or validation data).

In some embodiments, model selector engine 132 may be configured to receive input and/or transmit output to ML algorithms database 170. Similarly, featurization engine 120 can utilize storage or system memory for storing data and can utilize one or more I/O devices or network interfaces for transmitting or receiving data. ML algorithms database 170 may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative network (GNN), a generative adversarial network (GAN), a Word2Vec model, a bag of words model, a term frequency-inverse document frequency (TF-IDF) model, a generative pre-trained transformer (GPT) model (or other autoregressive model), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or any other type of model described further herein. Two specific examples of machine learning models that can be stored in the ML algorithms database 170 include versions DALL. E and CHAT GPT, both provided by OPEN AI.

System 100 can further include generative response engine 140 which is made up of a predictive output generation engine 145, and output validation engine 150 (e.g., configured to apply validation data to machine learning model output). Predictive output generation engine 145 can be configured to receive inputs from front end 172 that provide some guidance as to a desired output. Front end 172 can be a graphical user interface where a user can provide natural language prompts and receive responses from generative response engine 140. Front end 172 can also be an application programming interface (API) which other applications can call by providing a prompt and can receive responses from generative response engine 140. Predictive output generation engine 145 can analyze the input and identify relevant patterns and associations in the data it has learned to generate a sequence of words that predictive output generation engine 145 predicts is the most likely continuation of the input using one or more models from the ML algorithms database 170, aiming to provide a coherent and contextually relevant answer. Predictive output generation engine 145 generates responses by sampling from the probability distribution of possible words and sequences, guided by the patterns observed during its training. In some embodiments, predictive output generation engine 145 can generate multiple possible responses before presenting the final one. Predictive output generation engine 145 can generate multiple responses based on the input, and these responses are variations that predictive output generation engine 145 considers potentially relevant and coherent. Output validation engine 150 can evaluate these generated responses based on certain criteria. These criteria can include relevance to the prompt, coherence, fluency, and sometimes adherence to specific guidelines or rules, depending on the application. Based on this evaluation, output validation engine 150 selects the most appropriate response. This selection is typically the one that scores highest on the set criteria, balancing factors like relevance, informativeness, and coherence.

System 100 can further include feedback engine 160 (e.g., configured to apply feedback from a user and/or machine to a model) and model refinement engine 155 (e.g., configured to update or re-configure a model). In some embodiments, feedback engine 160 may receive input and/or transmit output (e.g., output from a trained, partially trained, or untrained model) to outcome metrics database 165. Outcome metrics database 165 may be configured to store output from one or more models and may also be configured to associate output with one or more models. In some embodiments, outcome metrics database 165, or other device (e.g., model refinement engine 155 or feedback engine 160), may be configured to correlate output, detect trends in output data, and/or infer a change to input or model parameters to cause a particular model output or type of model output. In some embodiments, model refinement engine 155 may receive output from predictive output generation engine 145 or output validation engine 150. In some embodiments, model refinement engine 155 may transmit the received output to featurization engine 120 or ML modeling engine 130 in one or more iterative cycles.

The engines of system 100 may be packaged functional hardware units designed for use with other components or a part of a program that performs a particular function (e.g., of related functions). Any or each of these modules may be implemented using a computing device. In some embodiments, the functionality of system 100 may be split across multiple computing devices to allow for distributed processing of the data, which may improve output speed and reduce computational load on individual devices. In some embodiments, system 100 may use load-balancing to maintain a stable resource load (e.g., processing load, memory load, or bandwidth load) across multiple computing devices and to reduce the risk of a computing device or connection becoming overloaded. In these or other embodiments, the different components may communicate over one or more I/O devices and/or network interfaces.

System 100 can be related to different domains or fields of use. Descriptions of embodiments related to specific domains, such as natural language processing or language modeling, is not intended to limit the disclosed embodiments to those specific domains, and embodiments consistent with the present disclosure can apply to any domain that utilizes predictive modeling based on available data.

The system 100 may include various types of ML models, such as a transformer. A transformer is a neural network architecture built into natural language processing (NLP) tasks, such as language translation, sentiment analysis, and text summarization. Conventional traditional recurrent neural networks (RNNs) process data in sequence, which slows the operations and training. A transformer or transformer network can process input in parallel and is faster and more efficient than sequential training and processing. In some aspects, transformers use a self-attention mechanism, which allows a transformer to identify the most relevant parts of the input text or content (e.g., audio or video). In some cases, transformers can also use a cross-attention mechanism which uses other content or data to determine the most relevant parts of the input. For example, cross-attention mechanisms are useful in sequential content such as a stream of data, such as optical flow, and other computer vision techniques.

A transformer model includes a multi-layer encoder-decoder architecture. The encoder takes the input text, converts the input text into a sequence of hidden representations and captures the meaning of the text at different levels of abstraction. The decoder then uses these representations to generate an output sequence, such as a text translation or a summary. The encoder and decoder are trained together using a combination of supervised and unsupervised learning techniques, such as maximum likelihood estimation and self-supervised pretraining. Illustrative examples of transformer engines include a Bidirectional Encoder Representations from Transformers (BERT) model, a Text-to-Text Transfer Transformer (T5), biomedical BERT (BioBERT), scientific BERT (SciBERT), and the SPECTER model for document-level representation learning. In some aspects, multiple transformer engines may be used to generate different embeddings.

An embedding is a representation of a discrete object, such as a word, a document, or an image, as a continuous vector in a multi-dimensional space. An embedding captures the semantic or structural relationships between the objects, such that similar objects are mapped to nearby vectors, and dissimilar objects are mapped to distant vectors. Embeddings are commonly used in machine learning, computer vision, and natural language processing tasks, such as language modeling, sentiment analysis, and machine translation. Embeddings are typically learned from large corpora of data using unsupervised learning algorithms, such as word2vec, Glo Ve, or fastText, which optimize the embeddings based on the co-occurrence or context of the objects in the data. Once learned, embeddings can be used to improve the performance of downstream tasks by providing a more meaningful and compact representation of the objects.

In some aspects, a generative response engine can be used in conjunction with supplemental models, such as a generator and a discriminator, which together form a GAN. A generator model generates data samples that resemble the distribution of a given dataset. For example, the generator takes random noise as input and transforms the noise into data samples that are indistinguishable from real data. The generator learns to produce realistic samples through training, often using techniques such as backpropagation and gradient descent, and is used for various applications, including image synthesis, text generation, and data augmentation. A discriminator is configured to distinguish between real data samples and fake or generated data samples produced by the generator. The discriminator learns to differentiate between real and generated data, providing feedback to the generator. In some cases, a discriminator can be trained in different contexts to differentiate between different safe and unsafe content.

In some aspects, the predictive output generation engine 145 may be executed using a neural engine for on-device execution. A neural engine that includes a plurality of neural processing cores that are configured to parallelize operations associated with neural networks. A neural processing core includes arrays of multiply-accumulate (MAC) units and specialized instructions that are optimized for matrix operations, such as convolution and matrix multiplication. A neural processing core receives input data and performs matrix transformations and nonlinear activation functions to break down and parallelize matrix operations. The neural processing core is configured to perform tasks such as inference (e.g., runtime operation of an ML model) or training of deep learning models and accelerates tasks by parallelization of larger computations that can be performed in parallel (e.g., matrix operations associated with neural networks). For example, a neural engine may perform computer vision tasks such as object recognition. In some cases, the neural engine can be implemented based on various ML libraries such as PyTorch, which interfaces with the compute unified device architecture (CUDA) to parallelize operations.

In one example, the predictive output generation engine 145 may be a small generative model that has fewer parameters, fewer layers, fewer neurons, or a simpler architecture compared to larger models. A small generative model may not capture the full complexity of the underlying data distribution as effectively as larger models but can still be useful in scenarios where computational resources are limited or where a simpler model is sufficient for the task. Small generative models can also be easier to train and interpret, making them suitable for certain applications. For example, ChatGPT-3.5 has 175 billion parameters and would result in a size of 1.4 Terabytes (TB) for a model implemented with double-precision floating point numbers. A smaller model may have a simpler architecture, use fewer parameters (e.g., 10 million), and use less precise numbers (e.g., single-precision floating point numbers) resulting in a size of 38 Megabytes (MB).

In addition, small models benefit from increased training based on local execution and data specific to a local device and a user of that local device. An additional benefit to small models is increased privacy because information is not transmitted over the network and only relies on information requested by the user or usage at the local device.

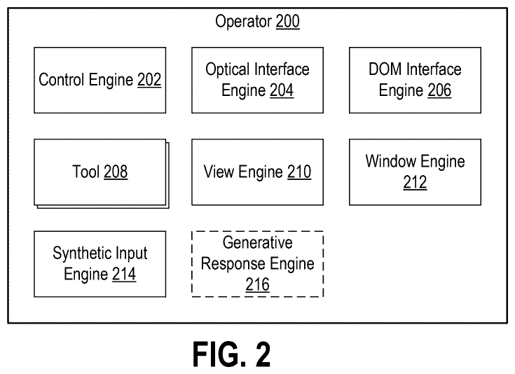

FIG. 2 is a conceptual block diagram of operator 200 in accordance with some embodiments of the present technology.

Operator 200 is a platform-agnostic software engine that is configured to bridge local application execution and cloud functionality using different interface mechanisms. For example, operator 200 may be developed using a cross-platform framework (e.g., React Native, Electron, Tauri, etc.) with interfaces that abstract different APIs into a single control plane. For example, operator 200 can control the window manager of different operating systems, and invoke common functions (e.g., retrieve a list of open files, ports, etc.). The operator may be compiled into native instructions using various languages (e.g., Rust, C, etc.), bytecode, or may be executed in a virtual machine that interfaces with the native hardware.

In some aspects, operator 200 may be configured to interact with different interface surfaces of various applications. For example, operator 200 may be configured to interact with a DOM of a browser, a webview-based application (e.g., Electron applications, Tauri, etc.), or another application that uses browser based-rendering (e.g., React Native). In another example, operator 200 may also use computer vision techniques to interact with other applications that use native rendering (e.g., using the API of an operating system (OS)).

Operator 200 includes control engine 202 that is configured to control the various components of the system. For example, control engine 202 is configured to select an interface engine for perceiving and interacting with an application. Non-limiting examples of an interface engine include optical interface engine 204 and DOM interface engine 206. Optical interface engine 204 is configured to perceive pixel-wise events and provide synthetic inputs. A synthetic input is an input that corresponds to a human input device (e.g., a keyboard, a mouse, etc.) but is input through an API or other corresponding user interface. DOM interface engine 206 is configured to perceive various DOM mutations (e.g., node removed, node added, node changed) and provide synthetic DOM events (e.g., invoking a function corresponding to a node). For example, DOM interface engine 206 may invoke an onClick event handler (e.g., a function) of a button with corresponding parameters.

In some cases, operator 200 can include other interface engines for interfacing with a different control surface of an application. For example, some applications (e.g., Microsoft Excel) include an API that bridges a surface area of the application with a document. In other cases, the application may be controlled through a command line interface or an agent (e.g., a dashboard application). In other examples, applications can include an AI interface that is configured to interface with other AI interfaces and operator 200 can include such AI interfaces for autonomously interfacing and controlling other applications.

Control engine 202 may also be configured to interface with at least one tool 208 for deterministic behavior. For example, tool 208 may be an instruction-based engine that uses explicit instructions to perform logic, math, and other conventional instructions. For example, tool 208 may be configured to assist operator 200 in disambiguating particular information in conjunction with a generative response engine. For example, the generative response engine can be a remote execution environment (e.g., cloud-based) and is limited in its ability to perceive the execution environment of operator 200. Tool 208 can be configured to provide deterministic information, for example, by identifying an email client associated with the user or identifying a default application associated with a particular type of file. Tools 208 are configured to provide a surface by which additional functions can be retrieved and deployed to complement the generative response engine and resolve ambiguities.

Control engine 202 may also be configured to control view engine 210 for controlling the view of the operator. In one aspect, operator 200 is configured as a translucent overlay over an application and displays a minimal user interface over the application or just outside of the application. View engine 210 is configured to control the rendering of content onto the translucent overlay to display content provided to and received from the generative response engine. The translucent overlay can appear anywhere from transparent to partially visible by adjusting an alpha blending factor. The view engine configures the translucent layer and the presentation of content in conjunction over the application.

Operator 200 may also include window engine 212 that is configured to control the windows in conjunction with the translucent overlay. For example, window engine 212 may integrate with an API and detect window events (e.g., focus, blur, resize, etc.). Window engine 212 may detect that a first application has the focus and may blur the application and apply the focus to the translucent overlay. In a window manager, an application has the focus when it is the source of input from a human input device (e.g., from a mouse or keyboard), and only a single application can have focus. An application having focus does not necessarily have to be foreground, and an application becomes blurred when the focus leaves (e.g., move to different application). The focus event is typically handled by an onFocus event handler and a blur event is typically handled by the onBlur event handler. For example, an animation can start when the onFocus event is detected, and the animation can stop when the onBlur event is detected. In this case, window engine 212 is configured to control the windows to move the translucent overlay of operator 200 in a seamless and consistent manner.

In some aspects, window engine 212 can define a scope of operator's control surface permit operator 200 to only provide control functionality to the focused window. For example, operator 200 is configured to only monitor, provide events, and generate inputs for a process associated with the window has the focus of operator 200. In this respect, the user controls the content that the generative response engine is able to perceive and potentially control. In some cases, system level events can cause the focus of the operating system to change and window engine 212 can distinguish between these events to maintain the scope of operator on the current application. For example, certain interactions can cause a sensitive application to execute and receive the focus automatically to allow input for various controls (e.g., allow screen sharing, permit an application to download a file into a download folder, etc.). In this example, window engine 212 can continue to apply operator 200 to an application the user was interacting with before the intervening window event, even though focus has changed based on a system event. Operator 200 provides necessary components to ensure that its focus follows the user intent and provides safety precautions to prevent the operator 200 from deviating from the user intent.

Window engine 212, as well as operating system primitives, can also deny operator 200 access to certain sensitive processes and corresponding windows. For example, operator 200 may deny associating operator 200 with a terminal window (e.g., terminal.app, powershell, a shell such as bash or zsh, etc.). In some cases, operating system primitives or operator 200 can also be configured to deny operator from receiving focus of an application. Window engine 212 can be orchestrate multiple application to have the scope of operator 200 to perform a particular task. For example, the user can invoke a command in operator 200 that allows the user to select which applications can be interacted with for a task to orchestrate the task and operator 200 can use the selected applications to orchestrate a result using multiple applications. For example, the user may request the generative response engine to compose music and a video montage based on a multiple photos and videos, and operator would access the selected applications to synthesize a musical composition in conjunction and insert the musical composition into a video editor application.

Control engine 202 can include input engine 214 to map inputs from the translucent overlay into a visible background application that is positioned to be visible through the translucent overlay. For example, the translucent overlay can have the focus, receive input, and invoke input engine 214 to selectively map the corresponding input into the visible background application. Input engine 214 may also map the input into operator 200 based on a state of operator 200. For example, operator 200 may display an input component (e.g., a text or audio input component) at an exterior edge of the visible background application's window, which can mutate the view of the operator (e.g., using view engine 210). View engine 210 can be configured to display a message history that is superimposed over the visible background application, and a portion of the visible background application can be temporarily configured for receiving human input (e.g. mouse events, keyboard events) into operator 200 in this view. For example, view engine 210 may be configured to display a message history as a three-dimensional (3D) list, with the earliest messages in the history appearing defocused in the background and having a decreasing margin between messages to create a 3D effect. When the mouse hovers over the earliest messages, view engine 210 may then display the message history as a flat two-dimensional (2D) list (e.g., having a constant margin between messages) to allow the mouse to access all messages.

View engine 210 dynamically controls the translucent display and the input surface into operator 200 to create a seamless user experience that allows the user to work within the visible background application while also being able to interface with a generative response engine in a convenient manner.

Operator 200 also includes input engine 214 that is configured to capture and relay input events. For example, input engine 214 can receive input while the translucent overlay is positioned over a window and then apply that input event to the window. Input engine 214 is also configured to generate synthetic inputs and synthetic events. A synthetic input is a controlled input by the operator that is registered in the device as a human input. For example, input engine 214 provides a mouse click at a particular coordinate, or input text into a particular region of a screen. A synthetic event is an event that is registered in the DOM that would correspond to human input. For example, a synthetic event could invoke generate an onClick event in a DOM element (e.g., a button) and the DOM element would then invoke the corresponding event handler (e.g., a callback function). Synthetic inputs and synthetic events are generated based on the interface of operator 200. For example, DOM interface engine 206 interfaces with a DOM-based application and responds to synthetic events, and optical interface engine 204 interfaces with a native-rendered application and responds to synthetic inputs.

In some cases, input engine 214 can also be configured to interface with a blurred application (e.g., a displayed application that does not have the focus) or an application that is currently hidden (e.g., minimized). In some cases, input engine 214 can take input into a virtualized version of the application (e.g., an image representing a background application or an application executing in a virtualized or cloud environment) and map the input to the application to perform remote control without being directly rendered at the local device.

In some cases, operator 200 may also include generative response engine 216 that is local to operator 200. Generative response engine 216 may be a small model that is configured for different tasks and is private with respect to the user. For example, generative response engine 216 may be configured specifically for user interactions at the local device. Generative response engine 216 can learn how a user responds, learn particular details of other people or devices with whom the user responds, and generate responses based on learned information. For example, a user may respond differently to emails or text messages from a client as compared to a family member. Generative response engine 216 may be able to use this learned knowledge to infer responses for the user. Generative response engine 216 may be a distilled version of generative response engine 140, or a different generative response engine entirely. The existence of generative response engine 216 does not necessarily prevent or obviate the use of generative response engine 140 for some tasks.

Control engine 202 may also configure operator 200 in different states and enable different levels of participation by a generative response engine. Non-limiting examples of different states include active, monitor, and passive. Active state refers to a currently running task in inference, whether a short-running task or a long-running task. During the active state, control engine 202 may also control the interface to output different visuals to a user in the case of different tasks. For example, control engine 202 controls view engine 210 to display a modal that illustrates specific subtasks to be performed and the status of those subtasks. The monitor state refers to a generative response engine that monitors the control of an application, such as monitoring input into an integrated development environment (e.g., visual studio code), a word processor, a calculator, a calendar, etc. In the monitor state, the generative response engine is configured to assist the control based on the content applied to the application. For example, the generative response engine can suggest a sentence that is more active based on the intended recipient (e.g., a client). In another case, the generative response engine can suggest code improvements during the monitor inference state. In the passive state, the generative response engine is configured to interact only based on direct input and instructions to do so (e.g., enter the active inference state).

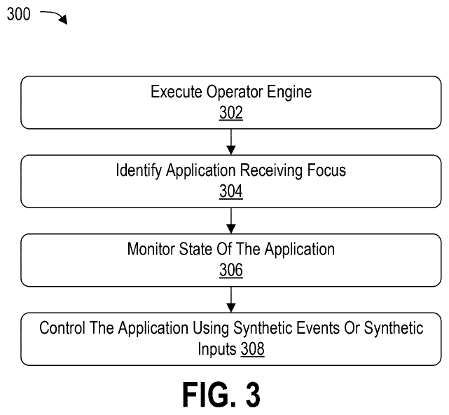

FIG. 3 illustrates a method performed by an operator in accordance with some embodiments of the present technology. Method 300 may be performed by a computing device such as a system on chip (SoC), or other computing component that receives instructions and performs the instructions.

At block 302, the computing device may execute the operator at block 302, which loads assets into memory. For example, the operator may include the various engines described above in FIG. 2.

At block 304, the computing system, which is executing the operator, may identify an application receiving focus. In some aspects, at block 304, the identification of the application is not necessarily the topmost window due to overlays, modals, and other window components. In some cases, at block 304, the operator may configure a translucent overlay on the application identified at block 304. Translucent overlay can include a graphical marker outside of the window of the identified application that indicates that the operator can interact or is interacting with this particular application through the window of the identified application.

At block 306, the computing system, which is executing the operator, may monitor the state of the application. For example, the computing system can intercept input into the operator and the operator may pass the input into the application. In other examples, the computing system can monitor the input and identify issues, improvements, corrections, and other artifacts associated with the content. The operator is configured to operate and interact with the computing system and the user differently during its lifecycle. For example, during the monitor state, the computing system is actively monitoring input and making suggestions based on known information to the operator. For example, when scheduling a flight, the operator may have access to a calendar and identify a conflict with a flight.

At block 308, the computing system, which executes the operator, may control the application using synthetic events or synthetic inputs. For example, in a calendar example in the monitor state, the operator may suggest moving an event based on the flight. In this manner, the operator is proactively assisting the user, while maintaining the privacy of the user. In other cases, the events at block 308 can be quite extensive, such as providing the computing system instructions to batch process images to improve visual fidelity, searching for particular contents within a document, etc.

In some cases at block 308, the computing system, which is executing the operator, may prompt the user for additional guidance. Some tasks, especially long-running tasks, can run into various obstacles and seek clarification from the user. For example, the operator may provide images or other types of output that the user can interact with to provide further information to the operator. The operator, thereby, is a highly capable assistant and may possess significant information about the user's life, including emails and conversations, without feeling intrusive. The operator can enable the handling of certain tasks and, for more intricate tasks, autonomously attempt solutions while seeking clarification from the user when necessary.

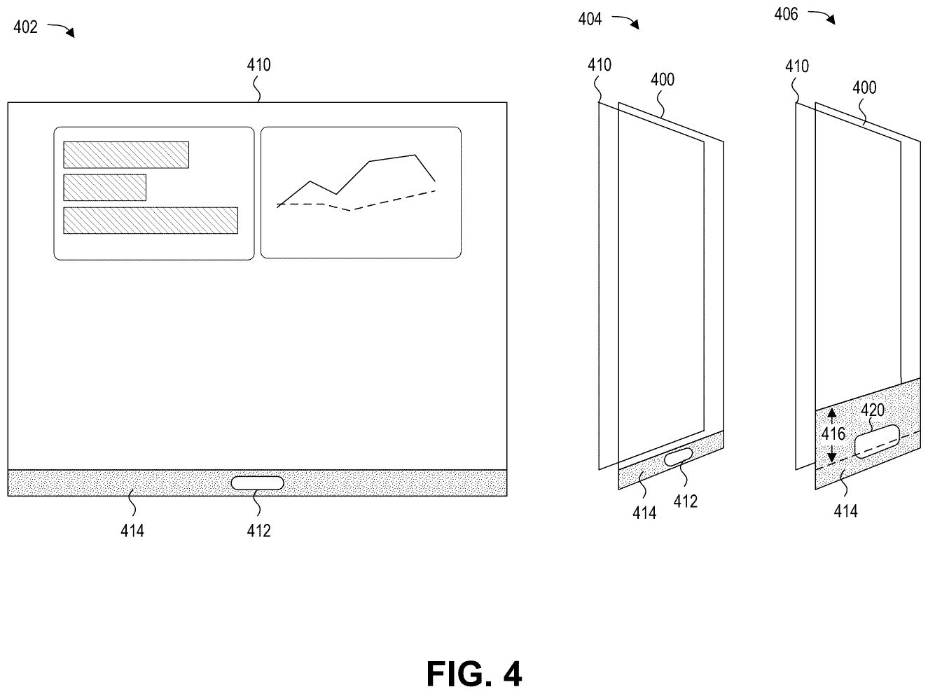

FIG. 4 is a conceptual diagram of an operator including translucent overlay 400 in accordance with some embodiments of the present technology. In particular, FIG. 4 illustrates the operator as plan view 402, first exploded view 404 of a first state, and second exploded view 406 of a second state.

In plan view 402, the operator includes translucent overlay 400 that is applied over application 410. In plan view 402, the operator includes graphical marker 412 that is displayed in hover region 414 that the operator can detect. Graphical marker 412 indicates that the operator is associated with application 410 and is positioned outside of a lower edge of application 410 (e.g., the hover region does not overlap application 410).

Exploded view 404 is a conceptual illustration of application 410 that logically lies below translucent overlay 400, graphical marker 412, and hover region 414 positioned at the lower edge of application 410.

Exploded view 406 illustrates a conceptual illustration of the operator when a mouse hovers in hover region 414. In this case, translucent overlay 400 is configured to animate graphical marker 412 into input component 420 (e.g., a text input component for inputting text into the operator). In this case, hover region 414 is configured to increase in vertical direction 416.

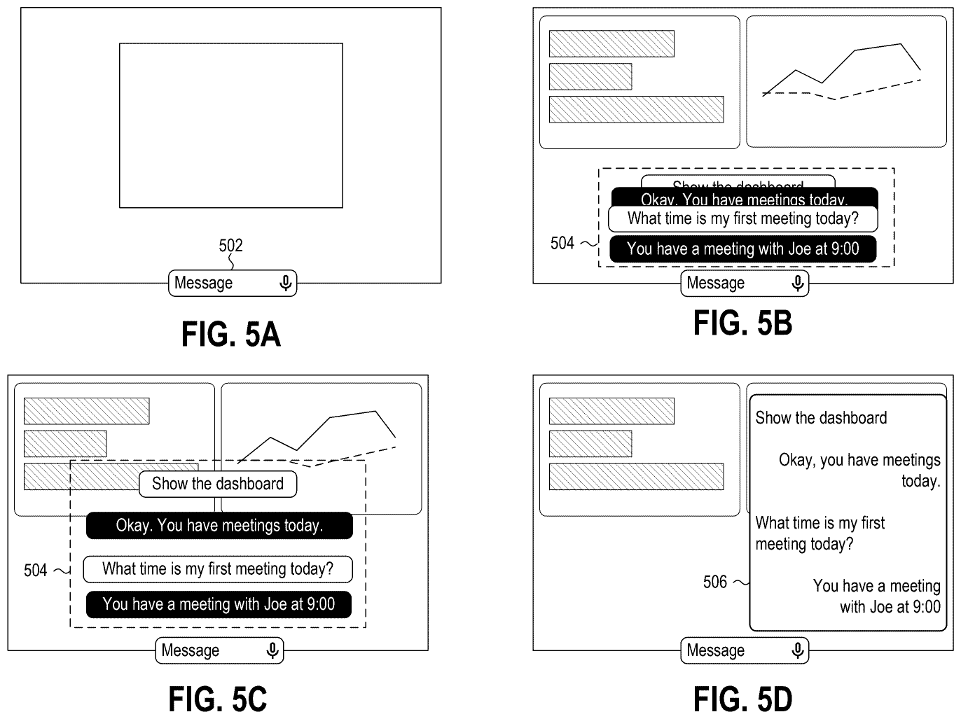

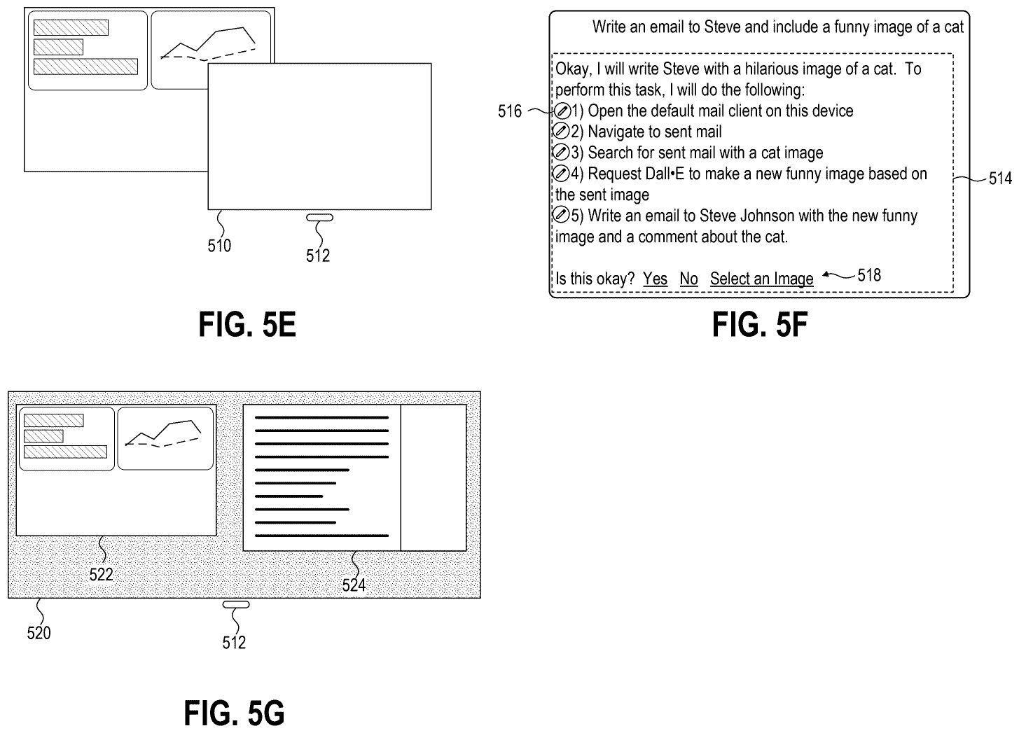

FIGS. 5A-5F are conceptual illustrations of a translucent overlay of the operator in accordance with some embodiments of the present technology. In FIG. 5A, input component 502, which is configured to receive multi-modal input (e.g., voice, text, etc.), has the focus for user input to control an application.

FIG. 5B shows an operator with message history 504 based on input into the input component and a state change that is applied by the operator based on message history 504. For example, FIG. 5B illustrates that the dashboard is displayed based on message history 504 using the operator, and information is requested from the dashboard using the operator. That is, the operator uses the inputs to query the generative response engine, which generates responses for the operator to input (e.g., using input engine 214) into the application (e.g., application 410. In this example, message history 504 is displayed using a 3D effect that modifies the margin of each message (and the z-order) to show that the message history fades into the background. A blur effect can be applied to the messages or borders of the message to more clearly illustrate a defocusing 3D effect.

FIG. 5C illustrates message history 504 display with a 2D effect. In some examples, hovering over message history 504 in different regions can expand the 3D effect in FIG. 5B to allow the user to interact with older messages. FIG. 5D illustrates that the message history can be expanded into modal 506. In this case, the translucent overlay functions can be disabled to allow the user to interact with the operator via modal 506 separately from the application. In this case, the operator can be invoked to present modal 506 in place of the translucent overlay. Modal 506 can be invoked with any suitable command (e.g., a keyboard shortcut) and maintains a relationship with modal 506 while the application has focus.

The operator can be moved between different applications based on focus. For example, as shown in FIG. 5E, when second application 510 receives the focus, the translucent overlay including graphical marker 512 (graphical marker 412 in FIG. 4) can be disposed over second application 510.

FIG. 5F illustrates the operator in conjunction with a long-running task. In this example, the operator is displayed as a modal because of the amount of text, as well as input required to modify this task. In this example, the user has prompted the generative response engine to write an email to a person (Steve) and include an image of a cat. In this case, the prompt illustrated in FIG. 5F includes multiple ambiguities such as the person (e.g., Steve Johnson or Steve Brown), an email client associated with the email (e.g., a native desktop application or a web-based application), an adjectival modifier (e.g., funny), and an object (e.g., a cat).

In this case, the generative response engine may be configured to generate plan 514 including subtasks that identify one or more inferences made while generating plan 514. For example, plan 514 identifies a default mail application, a source of content (e.g., sent mail), features to identify in the content (a cat in an image), and so forth. Plan 514 may include one or more input options to indicate a modification to plan 514, such as button 516 may be adjacent to each discrete task to allow modification of the specific task. For example, the user can modify the sub-task to indicate that the preferred mail client is a web-based client, or the user can modify the sub-task to indicate the correct recipient of the email. Plan 514 may also include the ability for the user to add an image via input options 518.

In some aspects, modifications to plan 514 can be extensive, such as providing learnable context or instructions. For example, the modification can include a link to learnable content that explains a particular technique, and the generative response engine can learn and apply the learnable content to plan 514.

FIG. 5F illustrates one example of a long-running task because it requires the use of multiple services, and requires multiple invocations of those different services. The operator may request the generative response engine to generate synthetic inputs or synthetic events based on these different subtasks of plan 514, and this can consume minutes, or it can consume hours in some cases. As an example, a user may prompt the generative response engine to plan a vacation including an entire vacation (e.g., including hotels, airfare, ground transportation) based on a particular and ambiguous goal (e.g., see all wonders of the world in a month). In other cases, the task could be requested to generate a meal plan and grocery shopping list with current ingredients.

In many cases, tasks performed by a generative response engine can be virtualized and performed off-premises. In some cases, the tasks can also be performed in the background, such as by invoking a headless browser (e.g., a headless browser has no direct visual output, is used for testing and data collection purposes, and may obtain screenshots at specific instances). In either case, the tasks can be visualized in conjunction with the operator to allow the user to visualize and inspect the operator's performance with respect to the task.

As noted above, the operator may also be configured in a monitor state, during which the operator is configured to interface with the generative response engine to identify content that can be modified or replaced for various purposes. For example, the generative response engine can be configured to identify bugs in software instructions or improvements in software instructions. Table 1 illustrates an example code that can be applied to an integrated development environment.

TABLE 1

```
function printNumbers( ) {
  for (var i = 0; i &lt; 5; i++) {
    setTimeout(( ) =&gt; console.log(i)}, 1000);
  }
}
printNumbers( );
```

The printNumbers function is supposed to log numbers from 0 to 4 with a delay of 1 second between each log. However, due to the use of var to declare the loop variable i, all of the setTimeout callbacks will share the same variable i, and by the time the callbacks are executed, the loop will have completed and i will have the final value of 5. As a result, the code will log 5 five times instead of logging 0, 1, 2, 3, and 4 as expected. The generative response engine can therefore suggest changing “var” to “let”, which creates a new variable at each iteration of the loop.

Another example of code that the generative response engine can improve is illustrated in Table 2, which generates a list of numbers greater than 10.

TABLE 2

let original = [0, 11, 15, 1, 9, 13, 2];
let filtered = [ ]; //initialize empty array
for (let i = 0; i &lt; original.length( ); i++) {
if (original[i] &gt; 10) filtered.push(original[i]);
}
console.log(filtered); // [11, 15, 13)

While Table 2 is valid code, it is verbose and antiquated based on arrow functions, which are sometimes referred to as anonymous functions or lambda expressions. The generative response engine may suggest an alternative using projection into the filter callback function illustrated in Table 3.

TABLE 3

let original = [0, 11, 15, 1, 9, 13, 2];
let filtered = original.filter(o =&gt; o &gt; 10)
console.log(filtered); // [11, 15, 13)

The filter function iterates through each value in the original variable and returns a value greater than 10, yielding the same result as the code in Table 2. However, the code in Table 3 is clearer because of its succinctness and clear declarative descriptions of its purposes without the extra semantics of the loop. In some examples, the operator can display the suggested changes in the transparent overlay, or provide some other notification to indicate a change. For example, when operator cannot directly interact with the application via an API, the operator can apply a color filter over the original content in Table 2 and change the background color or other style attribute, and a hover event over the color filter can display a change in a popup. For example, the background of the content in Table 2 can be converted to a bright yellow based on the operator. In another case, the operator can integrate into an API and may provide a notification of the change based on a capability within the application (e.g., IntelliSense, etc.). For example, an IDE can provide contextual highlighting to indicate a refactoring of code.

Although software instructions are described, the generative response engine can apply the above techniques to any interaction, such as conflicts in schedules. For example, the generative response engine in the monitor state, given an understanding of a user's calendar, may suggest a different date for a flight due to an event within the calendar. The monitor state can include numerous types of modifications, such as identification of typos and grammar, incorrect personal information, identification of potentially malicious actors requesting private credentials, and so forth.

FIG. 5G illustrates the operator in conjunction with a multiple application scope in accordance with some aspects of the disclosure. In this example, the operator may display container 520 illustrating a scope of the operator in connection with first application 522 and second application 524. In this example, first application 522 and second application 524 may be selected based on various techniques such as keyboard modifiers in conjunction with a mouse click (e.g., control keypress combined with a mouse click), may be dragged into or near first application 522, etc. Container 520 defines the scope of the operator and enables operator to combine content between the first application 522 and the second application 524 based on explicit permissions provided by user input operations.

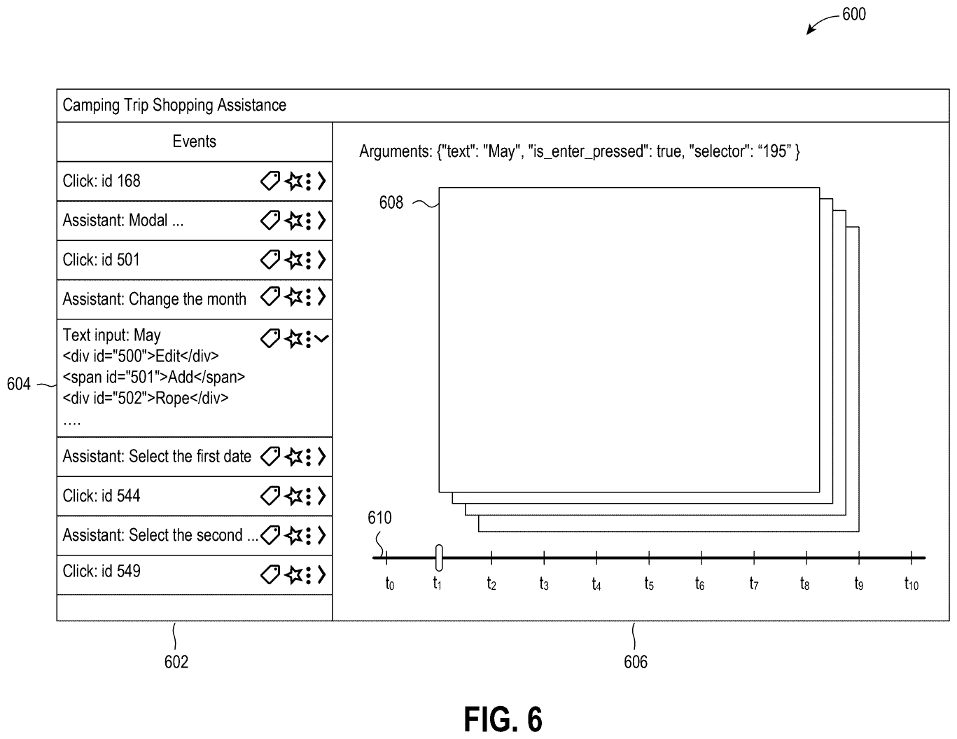

FIG. 6 illustrates a conceptual diagram of application 600 that is configured to generate training data using a DOM interface in accordance with some embodiments of the present technology. In some aspects, application 600 may also be configured to train an ML model, such as a generative response engine, using various types of learning. For example, application 600 may be configured to train the generative response engine using behavior-learning techniques. In the example illustrated in FIG. 6, application 600 is configured to interface with a DOM-based application, but application 600 may be a native-rendered application and would have some different parameters. For example, the identifiers of the markup elements would not be relevant and mouse and keyboard events (e.g., move the mouse to coordinates, click, etc.).

Application 600 includes list of events 602 (e.g., synthetic events) that are recorded by application 600 during the course of a campaign (e.g., camping trip shopping assistance). Application 600 also includes an inner monologue associated with the generative response engine to assist in developing an understanding of a trajectory of the generative response engine. In some cases, the inner monologue may be applied to a safety discriminator that is configured to identify unsafe actions. The safety discriminator may be a separate model and is configured to identify unsafe events (e.g., create an account, delete all files, provide private credentials, etc.) based on the content of the inner monologue. In some cases, the safety discriminator is a trained discriminator model, but there can be other models learned to identify safe actions through fine-tuning on curated datasets, filtering mechanisms, and content moderation policies.

Each event may also be expandable to further expand details, such as inspecting a portion of the DOM as shown at event 604.

Application 600 may also include event viewer panel 606 that displays at least one screenshot 608 associated with events 602. Event viewer panel 606 includes scrubber 610 that identifies distinct timesteps and screenshots corresponding to the campaign and associated with events. For example, application 600 may be configured to capture two screenshots associated with each event. A first screenshot is associated with the state prior to the event, and the second screenshot is associated with a responsive state. In some cases, the first and second screenshots can be delayed by a fixed value (e.g., 300 ms). In other cases, the screen may be continuing to refresh (e.g., data from a slow database). Application 600 may be configured to identify whether the screen render is completed. For example, application 600 may be configured to identify a loading element (e.g., also referred to as a spinner indicating that resources are being retrieved or contents are otherwise being loaded). Once the final render associated with the input has finished, application 600 may capture the second screenshot.

In some aspects, the timesteps (e.g., times t₀ to t₁₀ in FIG. 6) may be associated with the pair of screenshots. In this manner, application 600 captures a dynamic time-lapse of images based on the campaign as well as rich metadata in events 602. In some aspects, the data collected during the campaign can be used to train the generative response engine (e.g., using behavior cloning techniques), evaluate the generative response engine, or validate the generative response engine.

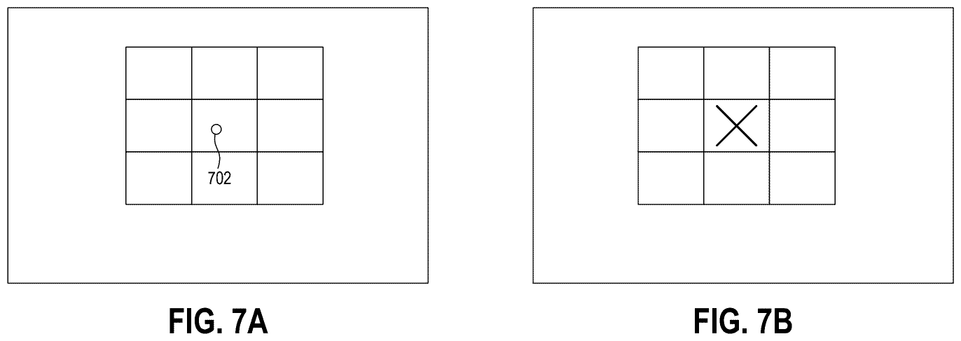

FIGS. 7A and 7B illustrate conceptual examples of a pair of screenshots captured by a training application (e.g., application 600 in FIG. 6) as part of a timestep. As shown in FIG. 7A, the first screenshot represents the user interface immediately prior to an input (e.g., user input during training, synthetic input during behavior cloning, etc.). For example, the input may be click on point 702. FIG. 7B illustrates the second screenshot that responds to the input that is captured after the user interface has responded and illustrates an X within a game of tic tac toe. The pair of screenshots can be used during training to learn how user interfaces respond to each event and train different types of interfaces (e.g., optical interface engine 204 and DOM interface engine 206) to interact with an agnostic application.

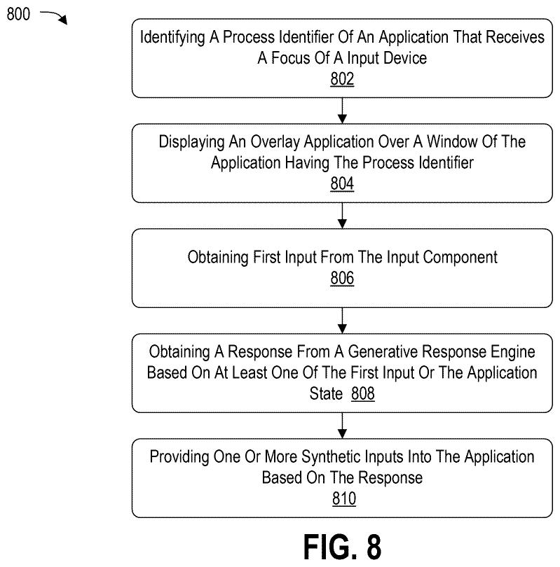

FIG. 8 illustrates an example method for generating an input in a user interface of application by a generative response engine. Although the example method 800 depicts a particular sequence of operations, the sequence may be altered without departing from the scope of the present disclosure. For example, some of the operations depicted may be performed in parallel or in a different sequence that does not materially affect the function of method 800. In other examples, different components of an example device or system that implements method 800 may perform functions at substantially the same time or in a specific sequence. Although a computing device (e.g., using an SoC), etc.) is described as performing the method, this example is for descriptive purposes. The method may be performed in a distributed manner using cloud computing, various containers, microservices, and other techniques.

In some cases, the computing system, executing the operator, may be configured to initiate an application based on a prompt into the operator. For example, a prompt may request to send an email, but the current application is an integrated development environment for writing software code. In this case, the computing system may identify, using the generative response engine, a tool to invoke the application based on the control interface. For example, the tool may be configured to assist operator in disambiguating particular information in conjunction with a generative response engine, such as which application to execute based on the input.

In other aspects, the computing system, executing the operator, may detect hovering of a human input device (e.g., a mouse, a keyboard, etc.) over the application. The computing system may, in response to detecting the hover, identify the process identifier associated with the application. In some cases, the operator may use information from the window manager to identify all open window components, filter particular irrelevant content (e.g., modals), and identify the window receiving the focus.

At block 802, the computing system may be executing an operator application that may configure the computing system to identify a process identifier of an application that receives a focus of an input device. In some aspects, the computing system may use the process identifier to position an overlay application that can interface with a generative response engine.

At block 804, the computing system may display an overlay application over a window of the application having the process identifier. For example, the overlay application may include an input component and receive the focus of the input device. In this example, the input component can be configured as a graphical marker (e.g., the graphical marker 512 in FIG. 5A) when the overlay application passes inputs through to a visible background application, and the input component may appear as a text input component on a border of the visible background application.

As part of block 804, the computing system may determine a control interface to interact with the application. In some examples, the control interface comprises at least one of a document object model, an application programming interface of the application, or a computer vision for perceiving the application. Applications are written in various frameworks and use different rendering components, such as components provided by the OS. These components may need to use computer vision and optical flow techniques to perceive the environment. Cross-platform frameworks may use a webview render layer (e.g., Electron) that accepts a DOM to render the application. Applications that use a webview render layer can be interfaced with the DOM itself. For example, instead of applying a click event to a button in the DOM, the DOM itself can be invoked via an event handler assigned to the button.

For example, when the control interface comprises the document object model, the computing system may extract the document object model associated with a current view of the application and provide the document object model to the generative response engine. In some cases, a virtual DOM may be used, which is a lightweight, in-memory representation of the real DOM. The virtual DOM mirrors the structure of the Real DOM, is not directly rendered to the screen, and may be a plain JavaScript object or data structure that is used for comparisons to identify changes in the DOM. In some cases, the generative response engine is configured to receive a screenshot including the window of the application in addition to the virtual DOM.

In another example, when the control interface comprises the API, the computing system may obtain the application state using the API. In some cases, applications may expose functionality to interact with objects through an API. As an example, Microsoft Office includes a Javascript bridge that can be accessed via an API to trigger events at the application level. For example, the entire document can be accessed, including metadata of the document, through the API.

At block 806, the computing system may obtain first input from the input component. The first input may comprise natural language associated with human-to-human interaction (e.g., text, audio). In addition, the first input an application state of the application, which is provided to a generative response engine to allow the generative response engine to identify how to interact with the application. In one example of block 806, the first input corresponds to one or more events from the input device (e.g., text input or sequential input such as a number of mouse moves and clicks).

The computing system may send the first inputs associated with the application to a generative response engine. In some cases, the computing system may also be able to understand the context of the application based on identifying a file identified by the process identifier (e.g., using the lsof shell command or a similar API call).

At block 808, the computing system may obtain a response from a generative response engine based on at least one of the first input or the application state. The generative response engine is configured to perceive the application based on the application state and identify the one or more synthetic inputs to achieve a task associated with the text.

At block 810, the computing system may provide one or more synthetic inputs into the application based on the response. In some aspects, a synthetic input can be an input applied by the operator based on controlling an API (e.g., move mouse to coordinates X and Y and then click). In this case, the application receives the one or more synthetic inputs while the overlay application has the focus. In other cases, the synthetic inputs can be a synthetic event. For example, if the application is a DOM-based application, the computing system may generate an event associated with the DOM. For example, the computing system can invoke the event handler corresponding to a button input (e.g., a function assigned to an onClick event).

In some aspects, to provide the one or more synthetic inputs, the computing system may obtain a local model for controlling the application based on instructions from the generative response engine. In this case, the local model is configured to provide the one or more synthetic inputs. The local model has benefits such as increased privacy and can be trained to learn more intimate detail that is only suitable for a local device and is not shared or used in any other context.

The computing system may also move the overlay application based on when a different application receives the focus. For example, the computing system may, in response to detecting an event or an input to cause a second application to receive the focus, identify coordinates of a window of the second application. The computing system may then move the overlay application over the window of the second application and apply the focus to the overlay application. In this case, the computing system may apply the blur to the second application (e.g., the onBlur event). However, this is an example, and there are various permutations of how the overlay could work, such as by not being visible at all.

In some cases, the computing system may control the operator to be a separate window modal. For example, in response to a view control input (e.g., a keyboard shortcut), the computing system may display an alternative view for interacting with the generative response engine. In the default view, the computing system may display a translucent overlay that is partially superimposed over the application. In the alternative view, the operator is a separate modal that is specifically associated with the window and its association does not change when the user switches to a different task. An example of a long-running task can also invoke a separate modal to allow parallelization as further described herein.

The computing system can be configured to perform long-running tasks. For example, the computing system may display a list of events to perform based on the first input corresponding to the text. The generative response engine can identify inferences made during the input and can make informed decisions about the input, but ultimately request that the user provide feedback regarding the plan generated by the generative response engine. For example, the list of events corresponds to the plan.

The list of events can be modified by user input. For example, the computing system may receive a second input to modify an event in the list of events. The generative response engine is configured to use information in the second input to generate the one or more synthetic inputs. For example, the user can provide files to facilitate the request, provide specific guidance (e.g., which email account to email a person from), remove specific items from the list, and provide general guidance.

In some cases, when the computing system is performing the events within the list of events, the computing system may capture information pertaining to the event. For example, the computing system may capture one or more images associated with a respective event, and each image corresponds to different states associated with the respective event at different times. In some cases, the computing system may capture one or more states associated with the respective event. Depending on the event and the application, the computing system may be able to capture the state and return the state. Some events are immutable, however, and cannot be reversed. The computing system may be able to display a time-series control to view one or more states at different times based on one or more images associated with the respective event, thereby allowing the user to perceive the different states.

In some aspects, the computing system may be configured to monitor and make suggestions in real-time into any application. For example, the computing system may obtain information from the generative response engine based on a first content in user input into the application and a context associated with the first content. The generative response engine may identify some issue with the input. For example, the generative response engine can identify a grammatical error once the sentence is complete or can identify a scheduling conflict from a different application, and so forth. The computing system may display a notification in the information related to second content to replace the first content. The second content includes an improvement or revision to the first content, or some other correction that the user should be notified of. Based on accepting the suggestions, the operator may replace at least the first content with the second content.

For example, during a long-running task, the operator may be configured as a modal tied to the application, and the user can monitor the execution of the long-running task as the modal, but switch execution to a different application. This allows the generative response engine to use the local device to perform two different tasks simultaneously. For example, the user is performing a task and the operator is performing a long-running task with the generative response engine.

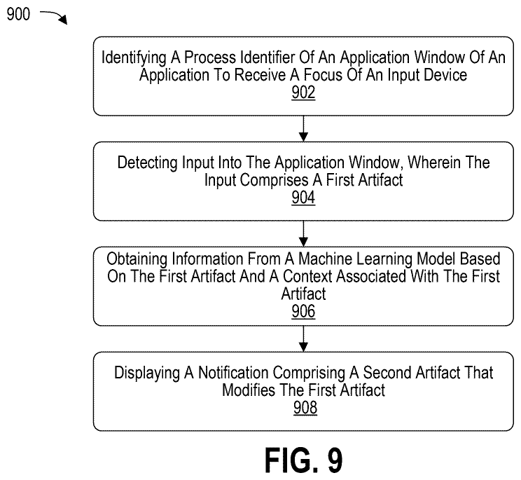

FIG. 9 illustrates an example method for generating a suggested improvement for content generated by a user by a generative response engine. Although the example method 900 depicts a particular sequence of operations, the sequence may be altered without departing from the scope of the present disclosure. For example, some of the operations depicted may be performed in parallel or in a different sequence that does not materially affect the function of method 900. In other examples, different components of an example device or system that implements method 900 may perform functions at substantially the same time or in a specific sequence. Although a computing device (e.g., using an SoC, etc.) is described as performing the method, this example is for descriptive purposes. The method may be performed in a distributed manner using cloud computing, various containers, microservices, and other techniques.

Since the generative response engine can monitor the user interface of the computing system, the generative response engine can occasionally provide helpful guidance and content to a user operating the computing system. As addressed below, the generative response engine may identify content provided by the user or inputs generated by the user, and determine that the user content or inputs would be more effective if revised.

At block 902, the computing system may be executing an operator application that may configure the computing system to identify a process identifier of an application window of an application to receive a focus of an input device. In this case, a translucent overlay may be omitted or the operator operates in a windowless mode for monitoring input only.

At block 904, the computing system may detect input into the application window. In this case, the input comprises a first content.

At block 906, the computing system may obtain information from a machine learning model based on the first content and a context associated with the first artifact identified in the content. For example, the artifact can be an error, a suggestion, or some correctable issue (e.g., a conflicting date, etc.).

At block 908, the computing system may display a notification comprising a second content that modifies the first artifact. For example, the notification is displayed in one of a translucent overlay application, the application window, or an operating system notification. The second content can include content that corrects the first artifact.

In some aspects, the computing system may insert the second content into the application in place of the first content. In this example, the operator is in the monitoring state and may become visible and active when information is presented to the user.

In some aspects, the generative response engine can be trained to determine when it should correct the first artifact, or determine when a notification with a suggestion to the user, or determine which artifacts the generative response engine should act on. It might make for a poor user experience if the generative response engine were making too many suggestions or corrections so the generative response engine can be trained for when it should make such suggestions or corrections.

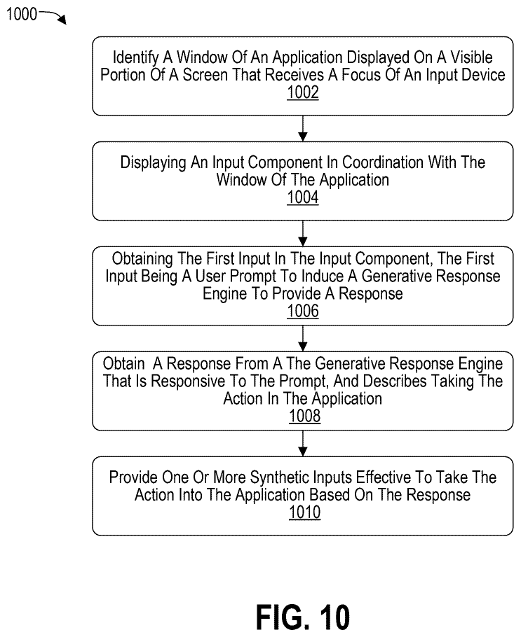

FIG. 10 illustrates an example method for determining a window in a user interface of a computing system that should receive an input in accordance with some embodiments of the present technology. Although the example method 1000 depicts a particular sequence of operations, the sequence may be altered without departing from the scope of the present disclosure. For example, some of the operations depicted may be performed in parallel or in a different sequence that does not materially affect the function of method 1000. In other examples, different components of an example device or system that implements method 1000 may perform functions at substantially the same time or in a specific sequence. Although a computing device (e.g., using an SoC, etc.) is described as performing the method, this example is for descriptive purposes. The method may be performed in a distributed manner using cloud computing, various containers, microservices, and other techniques.

At block 1102, the computing system may be executing an operator application that may configure the computing system to identify a window of an application displayed on a visible portion of a screen that receives a focus of an input device. In one aspect of block 1002, to identify the window, the computing system may detect a UI event received by a window manager of an operating system (e.g., the UI event may be the focus of the input device in the window of the application) and determine that the window of the application is valid for receiving using inputs using a window selection heuristic, wherein the window selection heuristic discriminates between windows that do not accept user inputs for input of content into the application (e.g., a banner, a notification, a confirmation dialog, etc.).

For example, an operating system of a computing system might generate many windows, but not all windows recognized by the operating system are windows that a user can interact with. Accordingly, the operator application can utilize a heuristic to identify windows that accept user inputs.

In another aspect of block 1002, to identify the window, the computing system (e.g. executing the operator application) may detect a UI event received by a window manager of an operating system (e.g., the UI event may be the focus of the input device in the window of the application) and determine that the window of the application is valid for receiving using inputs using a window selection heuristic. For example, the window selection heuristic discriminates between windows that do not accept user inputs for input of content into the application (e.g., a banner, a notification, a confirmation dialog, etc.). In some aspects, the window selection heuristic may use an API to identify windows that are visible and iterative through the windows to determine which window has the focus. In some cases, a top-most window does not have focus (e.g., a confirmation dialog).

In another aspect of block 1002, to identify the window, the computing system may capture at least one screen image, provide the at least one screen image to the generative response engine, and receive an instruction to display an overlay over the window of the application, wherein the generative response engine determined that the window is valid for receiving using inputs from the at least one screen image. In some cases, the operator application may provide window data from a window manager of an operating system.

At block 1004, the computing system may be configured to display an input component. For example, the input component is displayed in coordination with the window of the application. In this example, the input component is part of the operator application and is configured for the operator application to receive the first input associated with the window of the application.

At block 1006, the computing system may be configured to obtain, by the operator application, the first input in the input component, the first input being a prompt to induce a generative response engine to provide a response that pertains to taking an action in the application. For example, the computing system may receive a pointer event in the overlay over the window of the application which results in the display of the input component and may then receive a prompt from a user.

At block 1008, the computing system may be configured to obtain, by the operator application, a response from the generative response engine that is responsive to the prompt and describes taking the action in the application. The response from the generative response engine describes taking the action in the application by including instructions for interacting with the window of the application that are effective to take the action.

At block 1010, the computing system may be configured to provide, by the operator application, one or more synthetic inputs effective to take the action into the application based on the response. For example, the synthetic inputs may be associated with human input device events (e.g., move mouse to coordinates, press button, etc.) or may be associated with an DOM event (generate an onMouseDown event, etc.).

In some aspects, the computing system may move the window of the application off the visible portion of the screen and generate pseudo-window manager events to cause the window of the application to receive inputs as if it were in focus on the visible portion of the screen. For example, the computing system may move the window to coordinates that are not visible and the operator application can take the action by interacting with the window of the application while the window of the application is not on the visible portion of the screen. In some examples, the computing system may generate an image of the window and display the image in a visible portion of the screen, and a user is concurrently interacting with a second window displayed on the visible portion of the screen. In this case, the application appears to be receiving user inputs while the user is simultaneously interacting with the second application.

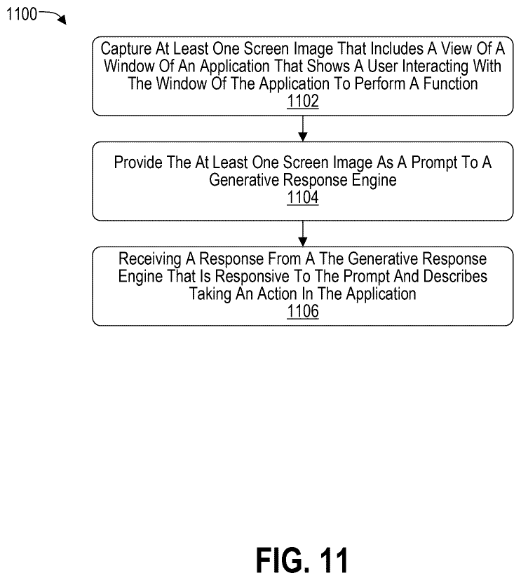

FIG. 11 illustrates an example method for generating an input in a user interface of application based on a response from a generative response engine in accordance with some embodiments of the present technology. Although the example method 1100 depicts a particular sequence of operations, the sequence may be altered without departing from the scope of the present disclosure. For example, some of the operations depicted may be performed in parallel or in a different sequence that does not materially affect the function of method 1100. In other examples, different components of an example device or system that implements method 1100 may perform functions at substantially the same time or in a specific sequence. Although a computing device (e.g., using an SoC, etc.) is described as performing the method, this example is for descriptive purposes. The method may be performed in a distributed manner using cloud computing, various containers, microservices, and other techniques.

At block 1102, the computing system may be executing an operator application that may configure the computing system to capture at least one screen image that includes a view of a window of an application. The at least one screen image shows a user interacting with the window of the application to perform a function.

At block 1104, the computing system may be configured to provide the at least one screen image as a prompt to a generative response engine. In this case, the at least one screen image represents a current state of the application for a generative response engine to provide further instructions. The at least one screen image is included in a prompt to the generative response engine.

At block 1106, the computing system may be configured to receive a response from the generative response engine. The response is responsive to the prompt and describes taking an action in the application based on the at least one screen image and includes a suggestion to the user to take the action that is different than an interaction shown in the at least one screen image, to perform the function. In this example, the generative response engine was able to identify the function the user is interacting with the window to perform and provide the suggestion based on the at least one screen image. The suggestion to the user is due to passive observation of the at least one screen image without a proactive prompt requesting the suggestion from the user. For example, the suggestion can be to correct an error that the generative response engine identified. In another example, the suggestion can be to clarify an ambiguity in the content.

The response can come in different forms. For example, the response can include oral content that is played through an audio system and includes the action. In another aspect, the response can be instructions to control the overlay to apply annotations and bring attention a portion of the application. For example, a response can include oral content to “press the settings button” and instructions to colorize a portion of the overlay over the settings button to create a highlight effect. In some cases, the overlay can be allow complex illustrations, such as an outline, arrows, and various other shapes to assist interactions with the application.

In one aspect, the computing system may, as part of block 1106, identify the window of the application when it has received a focus of an input device, displaying, by the operator application, an overlay over the window of the application, the overlay receiving the focus of the input device, and displaying, by the operator application, the suggestion to the user in the translucent overlay.

The computing system may provide (e.g., using the operator application) one or more synthetic inputs into the window of the application. The synthetic inputs into the window are effective to take the action in the application based on the response. In some cases, the synthetic inputs can be associated with a phantom view of the window. For example, the computing system may, while providing the one or more synthetic inputs in the window of the application, display a phantom view of the window of the application in a translucent overlay, whereby the user sees the phantom view and not the window of the application. For example, the phantom view can be an image of a window that is rendered at coordinates outside of a display region. After the computing system (e.g., executing the operator application) has completed the action by providing the one or more synthetic inputs, the computing system may make the translucent overlay substantially transparent to reveal the window of the application to the user.

In some other aspects, the computing system (e.g., executing the operator application) may, prior to providing the one or more synthetic inputs, provide a plan describing the one or more synthetic inputs for review by the user. The user may then provide additional inputs to modify the plan, provide additional context, and other inputs to control the plan. The computing system may receive an approval of the plan, which allows the computing system to begin execution of the plan (e.g., after any modification by the user).

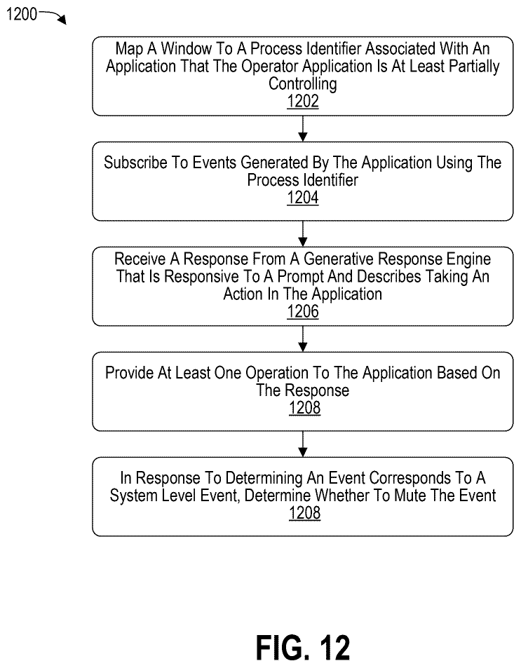

FIG. 12 illustrates an example method for preventing the generative response engine from taking an action in accordance with some embodiments of the present technology. Although the example method 1200 depicts a particular sequence of operations, the sequence may be altered without departing from the scope of the present disclosure. For example, some of the operations depicted may be performed in parallel or in a different sequence that does not materially affect the function of method 1200. In other examples, different components of an example device or system that implements method 1200 may perform functions at substantially the same time or in a specific sequence. Although a computing device (e.g., using an SoC, etc.) is described as performing the method, this example is for descriptive purposes. The method may be performed in a distributed manner using cloud computing, various containers, microservices, and other techniques.

Although, the generative response engine is to trained to control the computing system in a helpful and non-malicious way, the present technology can provide layers of safety systems. One such layer can include a system event monitor that can observe processes that are being invoked by applications under the control (or partial control) of the generative response engine, and terminate processes that the safety event monitor determines to be potentially malicious or unsafe.

Events that the safety event monitor might determine to be unsafe can include events that violate an information security policy, events that access sensitive computing system resources, or user specific events such as enforcing parental restrictions to a child's use of the computing system.

At block 1202, the computing system may be executing an operator application that may configure the computing system to map a window to a process identifier associated with an application that the operator application is at least partially controlling.

At block 1204, the computing system may be configured to subscribe, by the operator application, to events generated by the application using the process identifier. For example, an operating system can include a system event monitor to receive at least one event before passing the event to the application. The system event monitor (e.g., endpoint security) may be an API that subscribes to events based on a process identifier, and can be used to preempt events attempted to be taken by the application.

At block 1206, the computing system may be configured to receive a response from a generative response engine that is responsive to a prompt and describes taking an action in the application. The response may include at least one operation for the operator to perform in conjunction with the application (e.g., click an item, invoke an event handler function, etc.).

At block 1208, the computing system may be configured to provide at least one operation to the application based on the response, wherein at least one operation causes the application to generate at least one event (e.g., a click event, an event handler function, etc.).

At block 1210, the computing system may be configured to determine whether an event corresponds to a system level event and, in response to determining an event corresponds to a system level event, determine whether to mute the event. A system level event affects functionality, performance or security of a device or a network, and a non-system level event affects individual components or users. For example, the system level event includes at least one of a process event, an inter-process communication event, a path event, and a file system mount event. An example of a system level event includes a network operation, modifying or deleting a system file (e.g., a kernel or a driver) or configuration, and so forth. Any network operation can potentially leak user information and may require explicit confirmation by a user.

In another example of block 1210, the computing system may also determine whether the event corresponds to one-way event that cannot be reversed without additional information. For example, a one-way event may be a mutation or deletion of a file, or a modification to a system setting (e.g., a shell configuration, a global path change, etc.).

In one aspect, as part of block 1210, the computing system may display a notification identifying the event based on a rule associated with the event and permit the event to be executed based on a user response to the notification. For example, the computing system may determine that the event corresponds to the system level event based on a set of rules. The computing system may also distinguish between a source of the events. For example, the computing system can identify whether the source of the event is based on user input or a synthetic input or event.

In one aspect, at block 1210, the computing system can determine that the event generated based on identifying whether a source of the event corresponds to the operator application. For example, an operator application may subscribe to system event monitor based on events associated with a process identifier, and can preemptively stop the event before causing any harm. The computing system may also use the source of the event to apply different policies. For example, if the source of the event is user input, the computing system can permit the event based on system policies. On the other hand, if the source of the input is a synthetic input or event, the computing system can apply a different policy to prevent the generative response engine from exceeding its permitted scope.

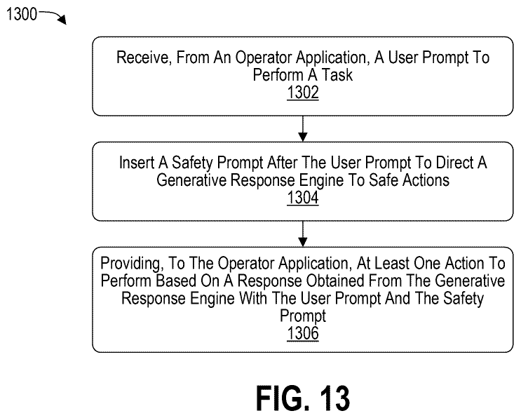

FIG. 13 illustrates an example method for supplementing prompts to guide a generative response engine to a safe response in accordance with some embodiments of the present technology. Although the example method 1300 depicts a particular sequence of operations, the sequence may be altered without departing from the scope of the present disclosure. For example, some of the operations depicted may be performed in parallel or in a different sequence that does not materially affect the function of method 1300. In other examples, different components of an example device or system that implements method 1300 may perform functions at substantially the same time or in a specific sequence. Although a computing device (e.g., using an SoC, etc.) is described as performing the method, this example is for descriptive purposes. The method may be performed in a distributed manner using cloud computing, various containers, microservices, and other techniques.

Unfortunately, for as long as generative response engines have been available, some users attempt to ignore security training built into them. Therefore, the present technology provides another layer of security protection that attempts to detect when a user is trying to use the generative response engine in an unsafe or inappropriate context.

At block 1302, the computing system may be configured to receive, from an operator application, a user prompt to perform a task. In this case, the user prompt is natural language that is not understandable by a machine without embeddings and further context provided by ML models. For example, the task can be a human readable sentence.

At block 1304, the computing system may be configured to add a safety prompt to the user prompt to direct a generative response engine to safe actions. The safety prompts provides context to the generative response engine to ensure that the generative response engine provides a safe response. The generative response engine is trained with a training dataset that includes only safe actions. Unsafe actions are types of network-based interactions that pose a higher risk of creating unintended consequences compared to information gathering.

In some aspects, the computing system may send information to a safety discriminator. For example, when the user prompt includes a screenshot illustrating a state of a client device, the computing system may send an inner monologue describing a task of the generative response engine, the screenshot, and the at least one action to a safety discriminator. In response to receiving an unsafe indicator from the safety discriminator, the computing system may generate a second user prompt with a safety prompt to prevent the task in the inner monologue. In this manner, the computing system can regenerate the prompt based on the correction of the task.

At block 1306, the computing system may be configured to provide, to the operator application, at least one action to perform based on a response obtained from the generative response engine with the user prompt and the safety prompt.

In some cases, the tasks can be filtered based on a collection of rules. For example, a request to perform a login function, reset a password, execute a remote script, execute a remote procedure call, and so forth can be filtered based on hard rules using simple pattern matching and complex pattern matching (e.g., regular expressions with forward and reverse search queries). In this case, the computing system may, when a network address included in the user prompt is associated with a denied action, generate an unavailable action prompt indicating this action is unavailable, and provide, to the operator application, a response from the generative response engine based on the unavailable action prompt.

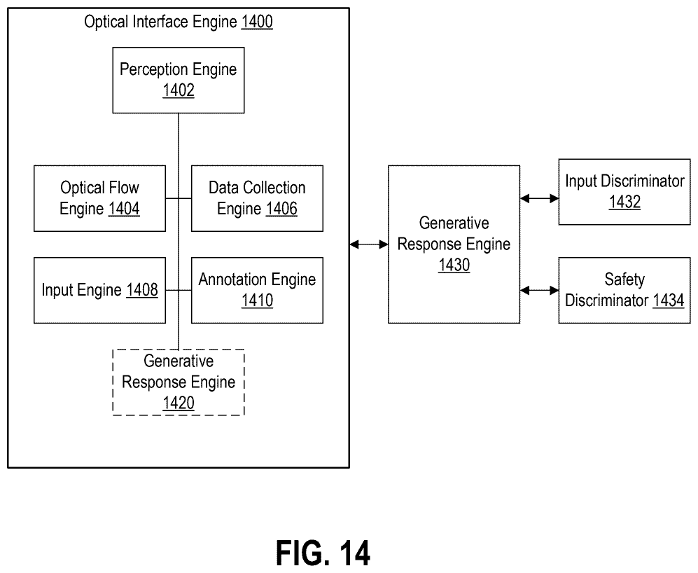

FIG. 14 illustrates a conceptual diagram of optical interface engine 1400 in accordance with some embodiments of the present technology. In some aspects, optical interface engine 1400 is configured as part of operator 200 (e.g., optical interface engine 204). Optical interface engine 1400 also be configured as a data collection application for supervised, unsupervised, or semi-supervised use. For example, optical interface engine 1400 can be used in different parts of a behavioral cloning training technique to learn user behavior and mimic user behavior.

In some aspects, behavior cloning is an ML technique used in supervised learning where an agent (e.g., optical interface engine 1400) learns to mimic the behavior of an expert or a demonstration dataset. For example, optical interface engine 1400 can be configured to collect data based on a person instructed for a specific task. The person generates the dataset by achieving this particular task by using optical interface engine 1400 as described below.

For example, optical interface engine 1400 may include perception engine 1402 for interacting with an application. Perception engine 1402 acts to bridge the application and generative response engine 1430. In this case, perception engine 1402 is configured to capture images associated with a state of the application.

Optical interface engine 1400 also includes optical flow engine 1404 for identifying information changes within the application. For example, optical flow engine 1404 can use various mechanisms to identify when the application is still changing in response to input (e.g., synthetic input) optical interface engine 1400. Optical flow engine 1404 also identifies when the application has ceased mutating in response to an input. For example, optical flow engine 1404 may downscale images and identify a pixel-wise difference. In other cases, optical flow engine 1404 may be an ML model configured to identify the optical flow, which is the movement of pixels between frames, to determine when the user interface of the application is not mutating.

In addition, optical interface engine 1400 also includes data collection engine 1406 for collecting data during the operation. Data collection engine 1406, for example, can capture screenshots of the application, as well as input applied to the application.

Data collection engine 1408 may also store information in the form of a timestep, which represents the interface at different times and corresponds to the event. In this case, a timestep refers to the period during which the user interface mutates in response to an event (e.g., invoking a button click). For example, a timestep can be associated with a first time before the event (e.g., before a click) and a second time after the application user interface settles (e.g., after a click). In some cases, the timestep can be associated with one or more events, such as moving the human input device (e.g., a mouse) to a location and then clicking. Table 4 illustrates a type definition of an example of a timestep and some of the properties such as screenshots (e.g., priorImage, laterImage), an optional inner monologue (e.g., monologue), and any events (e.g., event) that occurs within the timestep.

TABLE 4

```
type TimestepItem = {
  priorImage: UintArray8;
  laterImage: UintArray8;
  monologue?: string;
  events: HumanInputDeviceEvents[ ]
}
```

Examples of events include move, move and click, double click, drag, move, scroll, key (e.g., a key), multikey (e.g., press multiple keys such as control+alt+delete), type (e.g., enter multiple keystrokes), and wait.

Optical interface engine 1400 may also include annotation engine 1410, which is configured to receive information from the person or engine operating optical interface engine 1400. For example, annotation engine 1410 may use human input (e.g., voice, text, etc.) to annotate the data collected by data collection engine 1406 with an explanation. Annotation engine 1410 may also be configured to annotate the operation of the optical interface engine 1400 based on information from a generative response engine. For example, annotation engine 1410 may be configured to receive an inner monologue of a generative response engine (e.g., generative response engine 1420), which is described as the model's internal thought process as it analyzes data, makes predictions, and learns from its experiences. The inner monologue reflects these uncertainties as it weighs different possibilities and considers the evidence at hand. Through a process of trial and error (e.g., training), the ML model can refine its understanding and adjust predictions based on feedback from the environment. In this way, the inner monologue of an ML model metaphorically captures its ongoing process of analysis, learning, and decision-making as it interacts with data and refines its predictions over time.

In some examples, optical interface engine 1400 may also include generative response engine 1420, which can be on the local device or remote). For example, when optical interface engine 1400 may be autonomously controlled by generative response engine 1420 or in a supervised control environment in which a person is configured to intervene to prevent undesirable outcomes.

In some aspects, optical interface engine 1400 may include generative response engine 1420 for on-device training or inference. In some cases, generative response engine 1420 may be a small model that iteratively learns user operation of local applications and, in this way, can provide a highly customizable model without requiring network overhead.

In some aspects, optical interface engine 1400 may be configured for generating datasets in connection with behavioral cloning for generative response engine 1430. Generative response engine 1430 may be configured to generate synthetic input events based on screenshots provided by optical interface engine 1400. For example, generative response engine 1430 may store a context associated with optical interface engine 1400 for continued interaction, and the context can include a current screenshot, past screenshots, and past events (e.g., events in Table 4 above). In some cases, generative response engine 1430 can generate incorrect data, particularly with contextual inputs such as alternate clicks (e.g., right-click), hover events, and so forth. For example, generative response engine 1430 can generate an event that misses an intended target. Generative response engine 1430 may include input discriminator 1432 for providing feedback to generative response engine 1430 to facilitate training. For example, generative response engine 1430 may identify a current location of a mouse pointer (or corresponding information), extract a region of the current screenshot bordering the current location, and provide the extracted region and mouse click information to input discriminator 1432. Input discriminator 1432 may review the extract region, mouse data, and determine if the mouse event (e.g., mouse click) is within the intended target. If the intended event is not generated (e.g., the drag event misses the intended target), input discriminator 1432 generates a hint for generative response engine 1430, and generative response engine 1430 regenerates the event based on the hint. The input discriminator 1432 can be an ML model that uses feature extraction to identify the target based on feature extraction. In some cases, input discriminator 1432 can be a discriminator model, but may also be other types of models suitable for identifying important features (e.g., a transformer).

In some cases, generative response engine 1430 may also be further trained based on safety discriminator 1434, which is configured to identify unsafe and safe actions and provide feedback to generative response engine 1430. For example, generative response engine 1430 can provide safety discriminator 1434 with an intended event to perform next (e.g., press a button combination identified in a menu) and safety discriminator 1434 may determine whether the event is unsafe. In some cases, safety discriminator 1434 may receive an inner monologue of the generative response engine 1430 to identify unsafe operations before any steps are taken by generative response engine 1430. Safety discriminator 1434 is an ML model that is trained using various techniques for detecting multi-modal input that would be deemed unsafe (e.g., rf-rf, formatting drives, etc.).

Optical interface engine 1400 can be used in different contexts, such as pure data collection using humans to explain actions and build an initial dataset. Optical interface engine 1400 can also be used in a semi-supervised environment with a generative response engine that is configured to operate the optical interface engine 1400 and attempt one or more tasks, and a human to supervise the generative response engine and provide guidance to assist the generative response engine to achieve the task. The identification and the correction of error states provide meaningful data for training.

In some cases, optical interface engine 1400 can be used in a controlled environment to learn based on unsupervised techniques. In one illustrative example, a virtual machine can be configured in a controlled environment that mimics actual usage. For example, the virtual machine can be configured without a network interface to prevent any potential network activity, or virtual machine can deny all access to all networks except a local subnet. The virtual machine can also be loaded with default applications to learn to use and content to learn to understand in connection with one or more applications. Optical interface engine 1400 can be provided to the virtual machine to interact with the applications and content to perform various tasks in a safe and controlled environment. For example, optical interface engine 1400 can be tasked to edit an image in an image editor to scale the image and covert into a different file format. The results of different campaigns are reviewed and provided a reinforcement learning reward, as well as a suggestion at an inflection point within the campaign that recommends a different course of actions. For example, a trajectory of a campaign may launch a viewer application (e.g., image viewer), and the inflection point may annotate this action being an incorrect application for the desired function. As optical interface engine 1400 undertakes more campaigns and is provided with more rewards and inflection points, optical interface engine 1400 learns appropriate behavior for the desired task.

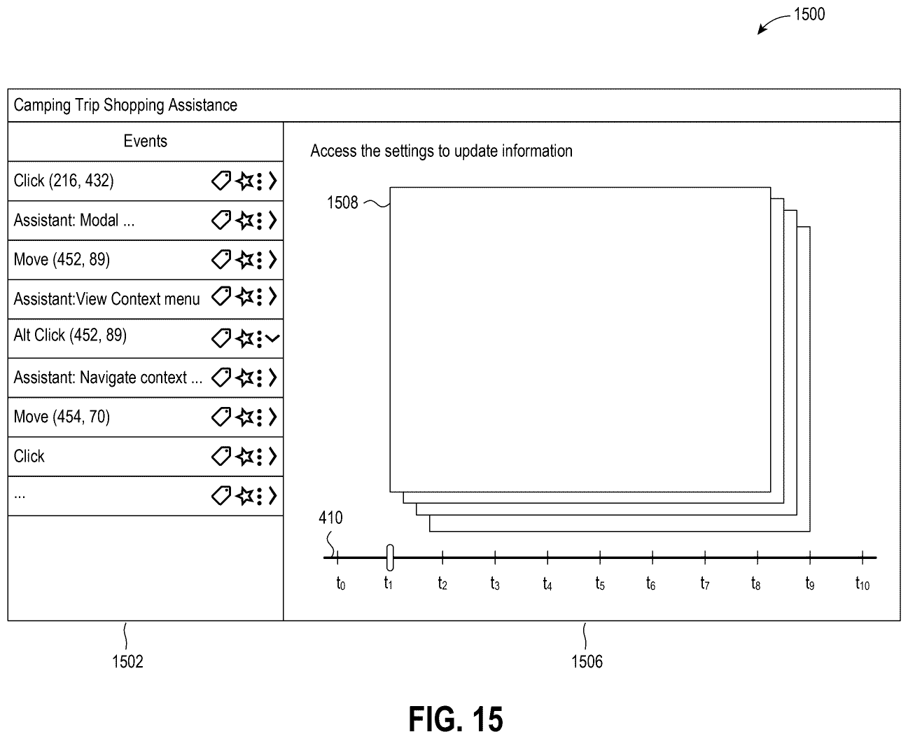

FIG. 15 illustrates a conceptual diagram of application 1500 that is configured to generate training data using a generic OS-based interface in accordance with some embodiments of the present technology. In some aspects, application 1500 may also be configured to train an ML model, such as a generative response engine, using various types of learning. For example, application 1500 may be configured to train the generative response engine using behavior-learning techniques. In the example illustrated in FIG. 15, application 1500 is configured to interface with a native application rendered with OS assets, but application 1500 may be a DOM-rendered application in some cases (e.g. operating a DOM-based application over a VNC connection). For example, the application 600 in FIG. 6 illustrates a DOM-based application.

Application 1500 includes a list of events 1502 (e.g., synthetic events) that are recorded by application 1500 during the course of a campaign (e.g., camping trip shopping assistance). A campaign is a generic task assigned to a human trainer or a generative response engine to attempt that task, and the task is configured to end with a success or failure. For example, a campaign may be an instruction for booking travel, purchasing a gift, and so forth. A campaign generally has many different ambiguities that the generative response engine may need to resolve. For example, if the task is to generate and send an email to a person, the ambiguities include what specific application performs the intended function (e.g., a local application for email or a web-based application), a recipient (which person), and so forth.

Application 1500 also includes an inner monologue associated with the generative response engine to assist in developing an understanding of a trajectory of the generative response engine. In some cases, the inner monologue may be applied to a safety discriminator (e.g., safety discriminator 1434) that is configured to identify unsafe actions. The safety discriminator may be a separate model and is configured to identify unsafe events (e.g., create an account, delete all files, provide private credentials, etc.) based on the content of the inner monologue. In some cases, the safety discriminator is a trained discriminator model, but there can be other models learned to identify safe actions through fine-tuning on curated datasets, filtering mechanisms, and content moderation policies.

Application 1500 may also include event viewer panel 1506 that displays at least one screenshot 1508 associated with events 1502. Event viewer panel 1506 includes scrubber 1510 which identifies distinct timesteps and screenshots corresponding to the campaign and associated with events. For example, application 1500 may be configured to capture two screenshots associated with each event. A first screenshot is associated with the state prior to the event, and the second screenshot is associated with a responsive state. In some cases, the first and second screenshots can be delayed by a fixed value (e.g., 300 ms). In other cases, the screen may be continuing to refresh (e.g., data from a slow database). Application 1500 may be configured to identify whether the screen render is completed. For example, application 1500 may be configured to identify a loading element (e.g., also referred to as a spinner indicating that resources are being retrieved or contents are otherwise being loaded). Once the final render associated with the input has finished, application 1500 may capture the second screenshot.

In some aspects, the timesteps (e.g., times t₀ to t₁₀ in FIG. 15) may be associated with the pair of screenshots. In this manner, application 1500 captures a dynamic time-lapse of images based on the campaign as well as rich metadata in events 1502. In some aspects, the data collected during the campaign can be used to train the generative response engine (e.g., using behavior cloning techniques), evaluate the generative response engine, or validate the generative response engine.

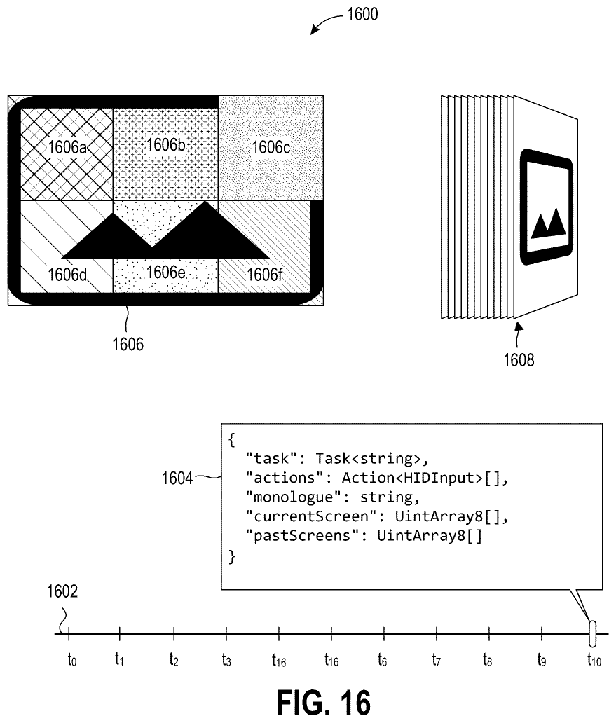

FIG. 16 is a conceptual illustration 1600 of an observation space of a generative response engine in accordance with some embodiments of the present technology. ML models such as a generative response engine have a model context in which a limited amount of information and context can be stored. In some aspects, an observation space is a heuristic rendering function that maps the history of observations (e.g., of optical interface engine 1400) within the context and actions to an image-text sequence.

The observation space includes data time series 1602 that is recorded and can be made available to a generative response engine or other applications (e.g., training, validation, etc.). Each timestep as shown in conceptual illustration 1600 is associated with a current screenshot of the optical interface engine and includes data 1604 having various properties, such as task (e.g., having a generic type of task, a list of the last N actions (e.g., Action&lt;HIDInput&gt;), a latest inner monologue (e.g., monologue), the current screenshot 1606 (e.g., currentScreen, which is a list of byte arrays or UintArray8[ ]), and the latest M screenshots 1608 (e.g., pastScreens, which is a list of byte arrays or UintArray8[ ] of length M).

In some aspects, current screenshot 1606 may be segmented into separate images (e.g., image 1606a, image 1606b, image 1606c, image 1606d, image 1606e, and image 1606f) based on an expected size associated with the generative response engine. For example, the generative response engine may be trained for feature extraction for images having a 512×512 size, and a size of the resolution of a screen associated with an optical flow engine is arbitrary (e.g., 3180×2160 for 4K, 2560×1440 for 2K, 2796×1290 for some portable devices, etc.). The optical flow engine may separate current screenshot 1606 into individual segments that are suitable for the generative response engine, thereby requiring the current screen to be represented as a list of byte arrays. The generative response engine may be configured to alternately view the separate images based on the desired view. For example, the generative response engine may want to understand the entire scope, and separate images (e.g., image 1606a-1606f) can be converted into a corresponding 512×512 image. In other cases, generative response engine may need to understand a scope of a particular window and may only use a single segmented image (e.g., image 1606b) or a cropped version of one or more images (e.g., half of image 1606a and half of image 1606e) to view a portion of the current screenshot for fine details.

The previous screenshots (e.g., pastScreens) are downscaled to a corresponding resolution of the generative response engine, such as 512×512 pixels. The past screenshots and inner monologue increase the average performance of the generative response engine based on providing suitable context and allow the generative response engine to improve inferences. For example, if generative response engine is provided a very large image, the generative response engine can decide to zoom out to more fully understand the context of the image.

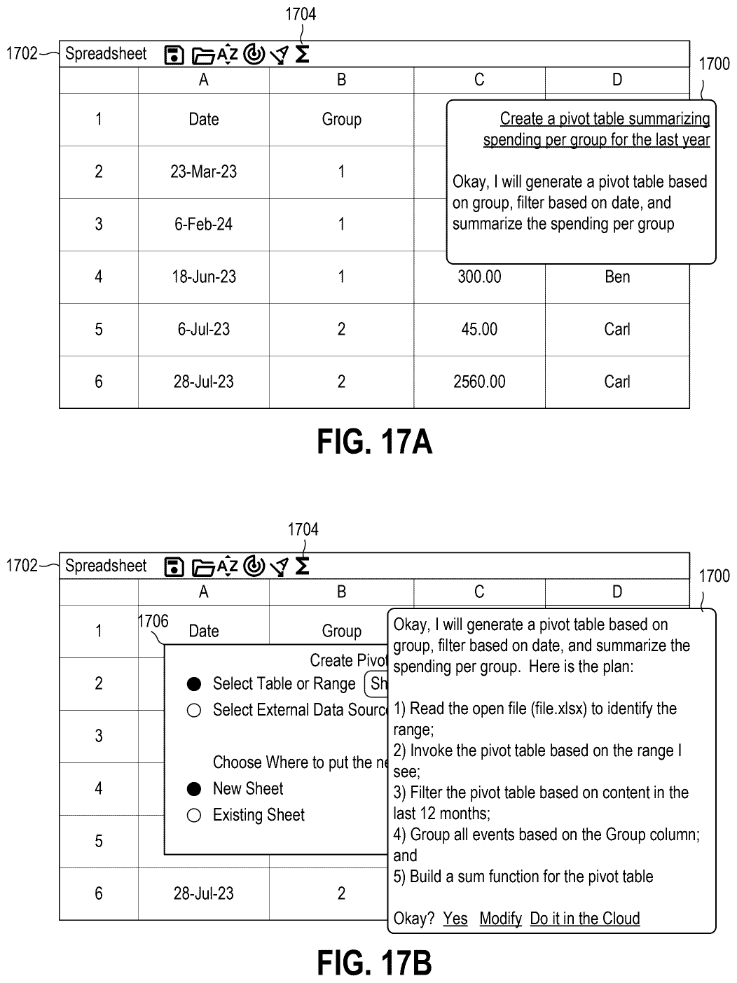

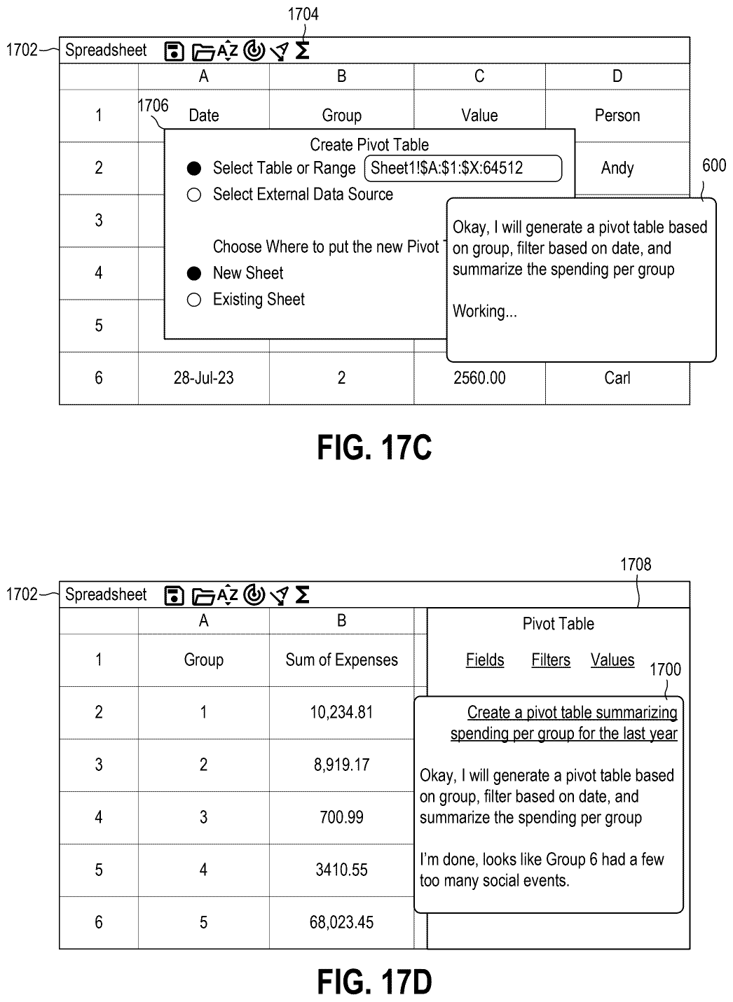

FIGS. 17A-17D are conceptual diagrams that illustrate a campaign that is being performed based on responses generated by a generative response engine in accordance with some embodiments of the present technology. In this example, an optical interface engine (e.g., optical interface engine 204) of operator 1700 is configured to interact with a local device to perform various human tasks based on instructions from the generative response engine and based on changes that happen within the local device.

For example, FIG. 17A illustrates that an application (e.g., spreadsheet 1702) is being executed. In this case, operator 1700 is configured as a modal for receiving input and controlling spreadsheet 1702 based on instruction from a generative response engine. For example, a user may provide a task to request a generative response engine to create a pivot table to summarize data within spreadsheet 1702. FIG. 17A illustrates a screenshot of the local system before input to generate the pivot table using, for example, button 1704. The screenshot in FIG. 17A may be provided to the generative response engine (e.g., the full-resolution screenshot of the local device).

Although a full resolution is described, in some cases, operator 1700 may scale the full-resolution screenshot based on view information. For example, if the view of the local system is scaled to increase the size of user interface controls (e.g., to 150%), operator 1700 can scale the image to reduce complexity. If the view of the local system is set for smaller user interface controls (e.g., 75%), the full resolution may be provided by operator 1700.

FIG. 17B illustrates that the generative response engine can present a plan to a local device based on the task. In this case, the task can include one or more subtasks that infer various information and request a user to provide additional information based on the various inferences. The user may be able to modify this request (e.g., No) and push the execution of the task to the cloud. The user can also provide additional disambiguating information (e.g., which email client, which person, etc.).

FIG. 17C illustrates a second screenshot responsive to the input event (e.g., move mouse to position corresponding to button 1704 and click) that occurs in the local device. That is FIGS. 17A and 17C illustrate a pair of screenshots of the local device representing a timestep. As shown in FIG. 17C, spreadsheet 1702 responds by adding a modal 1706 for controlling the pivot table identifying various parameters such as sheet (Sheet 1) and range (data in column: row notation from A:1 to X:64152).

In this case, operator 1700 is configured to interact with spreadsheet 1702 based on instructions from the generative response engine and based on screenshots provided to the generative response engine. In some cases, operator 1700 may also be configured to provide the corresponding file to the generative response engine to facilitate control. For example, based only on the screenshot, the generative response engine may be unaware of the entire context of spreadsheet 1702. Operator 1700 may interact with the local device to obtain a list of open files and provide the corresponding file to generative response engine. This action presumes that a user has given permission to share this information with the generative response engine. In other cases, a tool (e.g., tool 208) may be invoked to read the file locally and provide metadata to the generative response engine (e.g., the number of rows, the number of columns) of operator 1700. In some cases, operator 1700 may display a facade over spreadsheet 1702 (e.g., a bitmap corresponding to FIG. 17C) and perform scrolling operations to understand the contents of the file.

FIG. 17D illustrates a conclusion of the campaign of operator 1700, which has generated pivot table 1708 and corresponding parameters of the pivot table (not shown) to summarize data based on the prompt into operator 1700. Operator 1700 assumes control of spreadsheet 1702 and performs input response to the prompt based on knowledge learned by the generative response engine.

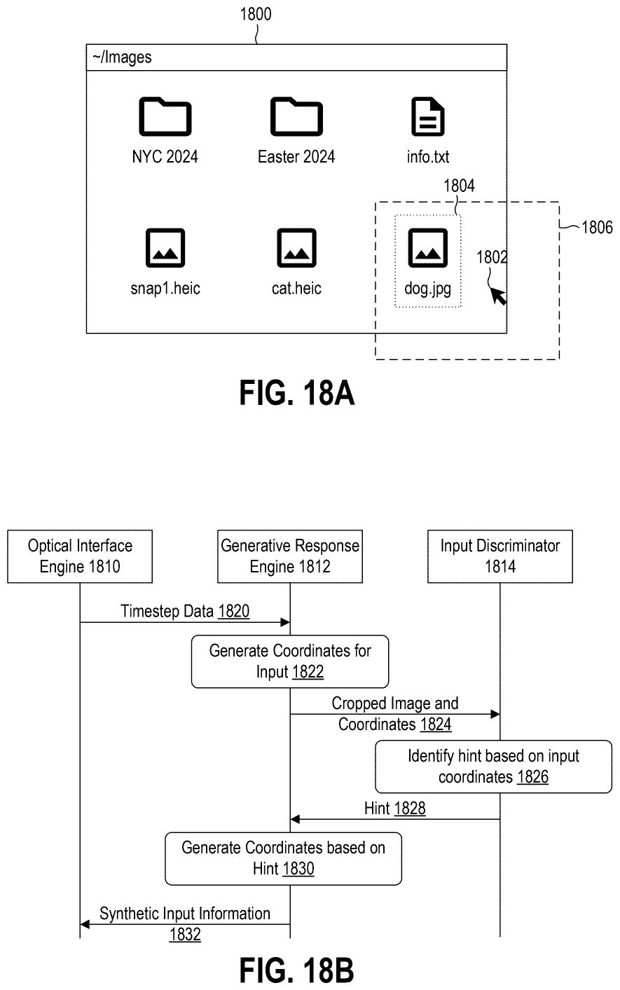

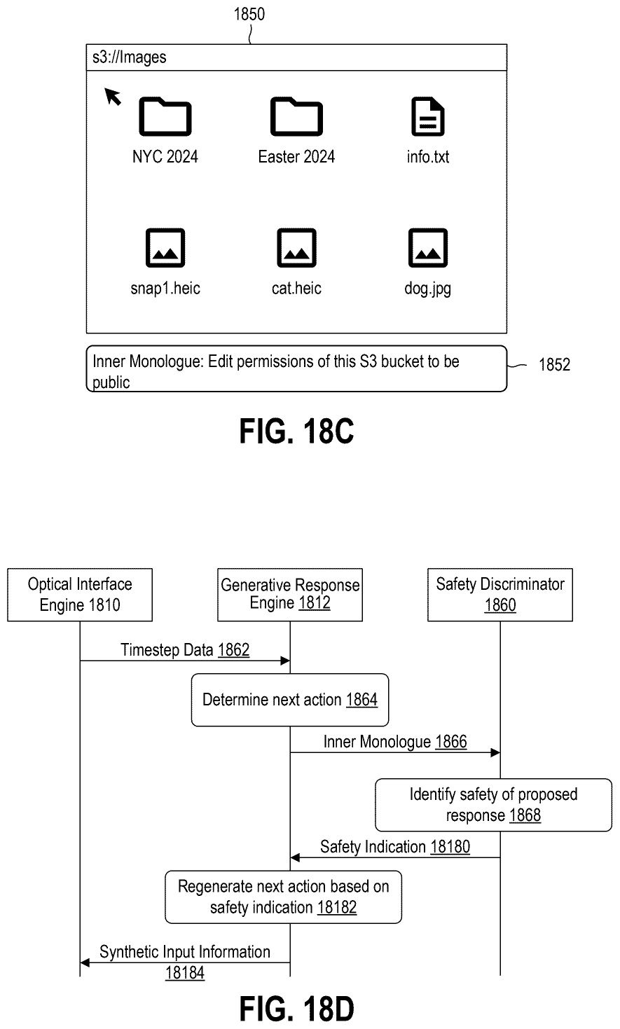

FIGS. 18A-18B illustrates the operation of an input discriminator to improve input generated by a generative response engine in accordance with some embodiments of the present technology. In this example, an optical interface engine (e.g., optical interface engine 204) of an operator (e.g., operator 200) is configured to interact with a local device to perform various human tasks based on instructions from the generative response engine.

FIG. 18A illustrates the operator is interfacing with the file manager 1800 to perform an action on a file within a current screenshot in accordance with some embodiments of the present technology. For example, the prompt into the operator may request resizing of an image to a particular resolution or converting the image to a different type. In this case, the operator is presumed to execute a default application of the image by a double click at coordinates 1802. However, coordinates 1802 are outside of a boundary 1804 of the corresponding file. Accordingly, double-clicking at coordinates 1802 will not invoke the intended application.

In this case, a generative response engine may be configured to extract region 1806 from the current screenshot and provide coordinates 1802 and region 1806 to an input discriminator to validate the input. In this case, the input discriminator can provide a hint to the generative response engine to move coordinates 1802. The generative response engine may use the hint and redetermine the coordinates on which to apply the double click. In some aspects, the boundary 1804 enables deeper contextual understanding, particularly for complex inputs such as drag operations, contextual inputs (e.g., alternate clicks to invoke a context menu, etc.).

FIG. 18B illustrates a sequence diagram of operations of a generative response engine in connection with an input discriminator in accordance with some embodiments of the present technology.

As shown in FIG. 18B, optical interface engine 1810 sends a portion of timestep data 1820 (e.g., a current screenshot) to generative response engine 1812, which generates coordinates associated with a synthetic input (e.g., click on coordinates X, Y) based on the current screenshot at block 1822. Generative response engine 1812 sends a cropped portion of the image (e.g., region 1806) and the coordinates to input discriminator 1814, which determines whether coordinates will interact with features within the cropped portion of the image. For example, input discriminator 1814 can include an ML model for feature extraction and classification of different types of inputs based on the feature. At block 1826, input discriminator 1814 determines hint 1828 (e.g., move coordinate left, coordinates are acceptable, etc.) to generative response engine 1812, which may then generate updated coordinates for input based on hint 1828. Generative response engine 1812 then sends synthetic input information to invoke a command at a local device. For example, the synthetic input information can be a double-click on coordinates within region 1806 in FIG. 18A.

FIGS. 18C-18D illustrates the operation of a safety discriminator for ensuring the safe operation of a generative response engine in accordance with some embodiments of the present technology.

FIG. 18C illustrates a cloud file manager 1850 to perform an action on a file within a current screenshot in accordance with some embodiments of the present technology. For example, the prompt into the operator (not shown) may request resizing of an image to a particular resolution or converting the image to a different type. In this case, inner monologue 1852 of a generative response engine may indicate to edit permissions of the S3 bucket to be public, which would allow any user of the internet to access this particular S3 bucket. In some aspects, a safety discriminator may receive inner monologue 1852 and prevent this operation because it is deemed unsafe. Non-limiting examples of unsafe operations include deleting files (local or cloud), deleting emails, deleting a user account, deleting comments, editing permission, logging in, resetting passwords, creating a new account, transferring data to remote location, renaming or move data, sending an email comment, interacting with bot, sending or receive payment, transactions that require a credit card, and using personally identifiable information (e.g., driver's license number, social security number, etc.).

FIG. 18D illustrates a sequence diagram of operations of a generative response engine in connection with a safety discriminator in accordance with some embodiments of the present technology.

In FIG. 18D, optical interface engine 1810 sends timestep data 1862 to generative response engine 1812 (e.g., a current screenshot), and generative response engine 1812 determines a next action to perform in connection with a task. Generative response engine 1812 generates inner monologue 1866 based on the next action of the task and sends generative response engine 1812 generates inner monologue 1866 to safety discriminator 1860. Safety discriminator 1860 is trained to discriminate safe and unsafe tasks and identifies the safety of the actions described in generative response engine 1812 generates inner monologue 1866. For example, safety discriminator 1860 may determine that the act of making an S3 bucket public in FIG. 18C is unsafe.

Safety discriminator 1860 sends a safety indication response 1870 to generative response engine 1812, which may regenerate a next action based on the safety indication response 1870 at block 1872. After block 1872, generative response engine 1812 may then send input information 1874 to the optical interface engine 1810 for application to a local device.

In FIGS. 18A-18D, an input discriminator and a safety discriminator are configured to record information pertaining to invalid inputs and unsafe inputs into the campaign. This data can be recorded in a suitable manner such that, when applied to a training engine for a generative response engine, the generative response engine can learn based on scenarios which it experienced adverse responses. Using reinforcement learning principles, the generative response engine can thereby be trained to include safe actions and accurate inputs, particularly in the context of complex user interactions such as double click, drag operations, etc.

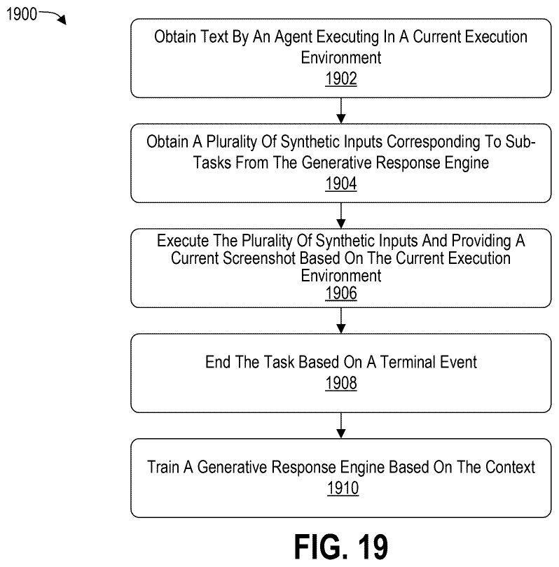

FIG. 19 illustrates an example method for generating data for training a generative response engine in accordance with some embodiments of the present technology. Although the example method 1900 depicts a particular sequence of operations, the sequence may be altered without departing from the scope of the present disclosure. For example, some of the operations depicted may be performed in parallel or in a different sequence that does not materially affect the function of method 1900. In other examples, different components of an example device or system that implements method 1900 may perform functions at substantially the same time or in a specific sequence. Although a computing device (e.g., using a processor, an SoC, etc.) is described as performing the method, this example is for descriptive purposes. The method may be performed in a distributed manner using cloud computing, various containers, microservices, and other techniques.

At block 1902, the computing system may receive text from an agent executing in a current execution environment. The text identifies a task for a generative response engine to perform. In some cases, the computing system may request a rule-based engine to identify the application based on the task. For example, preparing an email includes ambiguous information, such as how to prepare the email (e.g., using a local application or a web-based application).

At block 1904, the computing system may obtain a plurality of synthetic inputs corresponding to sub-tasks from the generative response engine, wherein the sub-tasks are related to an application to perform the task. A synthetic input comprises one of a mouse input or a keyboard input provided by the agent executing in the current execution environment. For example, the synthetic event can be configured as a device to invoke an API or other system call to perform a human input device operation (e.g., move mouse, click, drag, etc.). Block 1904 may also be asynchronous.

At block 1906, the computing system may execute the plurality of synthetic inputs and provide a current screenshot based on the current execution environment. The generative response engine stores a context associated with a plurality of timesteps corresponding to the current execution environment during the task. The context is an observation space of different timesteps and comprises the task, the current screenshot at a first resolution, prior screenshots scaled to a second resolution for input into the generative response engine, synthetic inputs applied to the current execution environment, and an inner monologue of the generative response engine.

The current screenshot may be provided to the generative response engine as a plurality of images at the second resolution, and tokens associated with the context are mapped to a corresponding image of the plurality of images. For example, when features are extracted by a generative response engine (e.g., tokens), the tokens are each mapped to the specific image.

The computing system may, using the generative response engine, synthesize the plurality of images into a downscaled image at the second resolution to identify a next sub-task of the task or identify a first image of the plurality of images to identify the next sub-task of the task. In some cases, the generative response engine may need specific details, would use higher detail content, and may need larger context and the different levels of image detail to increase understanding of the context.

The events described in connection with block 1904 and following block 1904 are asynchronous and may occur over a period of time. For example, the computing system, as part of block 1906, may capture data associated with different timesteps. To capture information associated with a single timestep, the computing system may provide a first current screenshot to the generative response engine associated with a start time of the timestep, apply a first synthetic input obtained from the generative response engine based on the first current screenshot, determine an end time of the timestep, and obtain a second current screenshot corresponding to the end time of the timestep. In this example, the end time corresponds to an end of a response of the application based on the first synthetic input, and the first current screenshot and the second current screenshot are stored in the context at the second resolution.

In some cases, the generative response engine is configured to provide a portion of the current screenshot to an input discriminator related to a first synthetic input and receive a hint from the input discriminator to adjust a coordinate of the first synthetic input. The input discriminator is configured to identify an input missed event that does not accurately reflect the intended target and may provide the hit to the generative response engine.

The generative response engine may also be configured to provide the inner monologue to a safety discriminator. The safety discriminator is configured to identify the terminal event based on actions outside of a learned safety context. For example, the inner monologue should not permanently mutate aspects such as stored files, emails, and so forth.

At block 1908, the computing system may end the task based on a terminal event. For example, the terminal event may be ending a trajectory of the task based on a maximum number of events being reached, completion of the task, or a safety discriminator identifying an action to be performed by the generative response engine

At block 1910, the computing system may train the generative response engine based on the context of the generative response engine. For example, the computing system or a combination of other computing systems (e.g., an array of GPUs) may be configured to train the generative response engine to perform a plurality of tasks based on the plurality of events and annotations in the plurality of events.

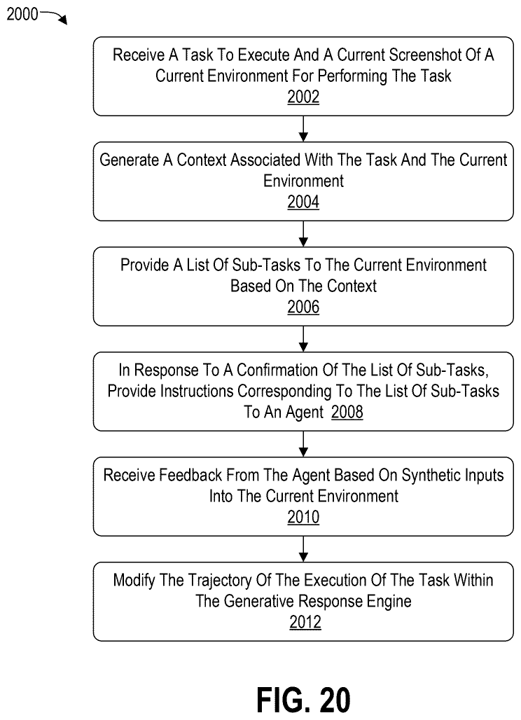

FIG. 20 illustrates an example method for controlling a remote device based on a task provided to a generative response engine in accordance with some embodiments of the present technology in accordance with some embodiments of the present technology. Although the example method 2000 depicts a particular sequence of operations, the sequence may be altered without departing from the scope of the present disclosure. For example, some of the operations depicted may be performed in parallel or in a different sequence that does not materially affect the function of method 2000. In other examples, different components of an example device or system that implements method 2000 may perform functions at substantially the same time or in a specific sequence. Although a computing device (e.g., using a processor, an SoC, etc.) is described as performing the method, this example is for descriptive purposes. The method may be performed in a distributed manner using cloud computing, various containers, microservices, and other techniques.

At block 2002, the computing system may obtain a task to execute and a current screenshot of a current environment for performing the task.

In one example, the current environment is executing in a first device and the task is provided from a second device. In some aspects, the computing system may move the current environment from a local client device to a remote environment. For example, the computing system may move the execution of an application into a virtualized environment, and may provide visual feedback (e.g., a dynamic time-lapse of events) to different devices of a user. For example, the computing system may provide screenshots based the trajectory of the execution of the task in the remote environment to the local client device.

At block 2004, the computing system may generate a context associated with the task and the current environment in connection with a generative response engine. The context is stored in the ML and includes a current screenshot, previous screenshots, actions, an inner monologue, and so forth. The generative response engine is trained to accept images and relate features in the text with features in the images. In addition, the generative response engine is trained to identify and interact with user interfaces based on the images and the text.

At block 2006, the computing system may provide a list of sub-tasks to the current environment based on the context. The list of sub-tasks identifies an application corresponding to the task and one or more synthetic events to apply into the current environment. For example, the one or more synthetic events are inputs corresponding to one or more human input devices.

In some aspects, the computing system may request a rule-based engine to identify the application based on the task and the current environment. For example, the rule-based engine may be a tool in the current environment (e.g., a user's local device) that disambiguates information for the generative response engine. For example, the tool may identify local applications suitable for a particular function.

In some aspects, the computing device may receive a modification request to the task. In response to a modification request, obtain a modified list of sub-tasks based on information in the modification request. For example, the user may request a particular image be used, provide instructions pertaining to the request, etc. The computing system may, in response to a modification request, obtain a modified list of sub-tasks based on a requested modification. The computing system can provide the list to the user, and, in response to confirmation (e.g., user confirmation) of the list of sub-tasks, perform the tasks in the modified list.

At block 2008, the computing system may, in response to a confirmation of the list of sub-tasks, provide instructions corresponding to the list of sub-tasks to an agent based on a trajectory of the execution of the task and the current environment.

At block 2010, the computing system may receive feedback from the agent based on synthetic inputs into the current environment. For example, the task may become stuck due to an unfamiliar interface or be unable to perform an event to generate helpful information. In this case, a supervisor (e.g., a person) can provide input into an agent executing in a local client device to assist the generative response engine.

At block 2012, the computing system may modify the trajectory of the execution of the task within the generative response engine.

In some cases, a portion of the method 2000 can be relocated. For example, the computing system may move the current environment from a local client device to a remote environment. As an example, the user of the local client device requests the generative response engine to perform a long-running task in a cloud-based environment. A virtual machine can be initiated with the information, and screenshots of the execution can be captured within the virtual environment. The computing system may provide screenshots based on the trajectory of the execution of the task in the remote environment to the local client device. In this case, the tasks can be virtualized, moved between devices (e.g., the user can monitor the task from different devices), and receive the result irrespective of the origination.

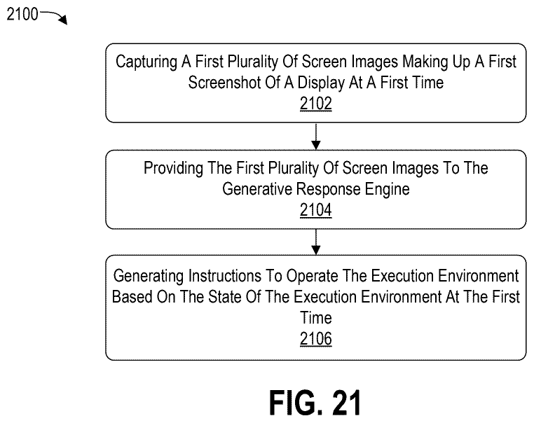

FIG. 21 illustrates an example method for controlling a remote device based on a task provided to a generative response engine in accordance with some embodiments of the present technology. Although the example method 2100 depicts a particular sequence of operations, the sequence may be altered without departing from the scope of the present disclosure. For example, some of the operations depicted may be performed in parallel or in a different sequence that does not materially affect the function of method 2100. In other examples, different components of an example device or system that implements method 2100 may perform functions at substantially the same time or in a specific sequence. Although a computing device (e.g., using a processor, an SoC, etc.) is described as performing the method, this example is for descriptive purposes. The method may be performed in a distributed manner using cloud computing, various containers, microservices, and other techniques.

At block 2102, the computing system may capture a first plurality of screen images making up a first screenshot of a display at a first time. The first plurality of images are of a fixed image resolution irrespective of a resolution of the display. In one example, the execution environment is an operating system executing on a personal computing device.

At block 2104, the computing system may provide the first plurality of screen images to the generative response engine. The generative response engine perceives a state of the execution environment at the first time from the plurality of screen images.

At block 2106, the computing system may generate instructions to operate the execution environment based on the state of the execution environment at the first time. The instructions to operate the execution environment include a wait instruction, the wait instruction informs an operator application to delay capture of an additional screenshot of the display for a period in which the generative response engine predicts the execution environment will not likely update its display with information useful to the generative response engine, wherein the operator application is configured to receive the instructions to operate the execution environment.

The computing system may be configured to perceive execution of tasks based on a time-series of images. For example, the computing system may capture a second plurality of screen images making up a second screenshot of the display at a second time, and the second plurality of screen images are of the fixed image resolution irrespective of the resolution of the display. The computing system may then provide the second plurality of screen images to the generative response engine, and the generative response engine perceives the state of the execution environment at the second time from the second plurality of screen images and the first plurality of screen images.

In some cases, the time-series of images can be related to a task that requires a generative response engine to perform several discrete tasks. The computing system may provide the instructions to operate the execution environment as a list of sub-tasks to the operator application. The list of sub-tasks identifies an application corresponding to the task and one or more synthetic events to apply into a current environment. The computing system may then receive feedback from the operator application based on synthetic inputs applied by an operator to the current environment. In this case, the synthetic inputs were derived from the list of sub-tasks.

The computing system may also predict a user intent from user interactions shown in the first plurality of screen images and the second plurality of screen images, and then generate a suggestion, by the generative response engine, to a user to take an action that is different than the user interactions shown in the first plurality of screen images and the second plurality of screen images to achieve the user intent. The generating of the suggestion results from passive observation of the first plurality of screen images and the second plurality of screen images without receiving a user-provided-prompt requesting the suggestion.

In some cases, the display can be a virtual display such that the first screenshot is of the virtual display that is not presently rendered to a physical display device.

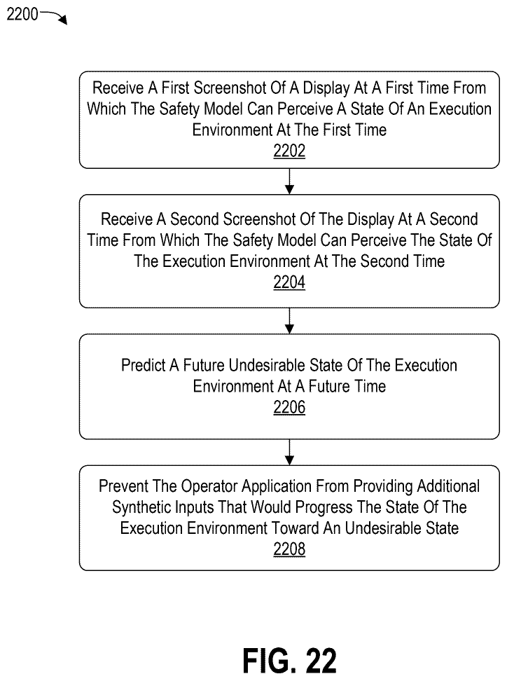

FIG. 22 illustrates an example method for preventing unsafe or non-permitted tasks using a safety model in accordance with some embodiments of the present technology. Although the example method 2200 depicts a particular sequence of operations, the sequence may be altered without departing from the scope of the present disclosure. For example, some of the operations depicted may be performed in parallel or in a different sequence that does not materially affect the function of method 2200. In other examples, different components of an example device or system that implements method 2200 may perform functions at substantially the same time or in a specific sequence. Although a computing device (e.g., using a processor, an SoC, etc.) is described as performing the method, this example is for descriptive purposes. The method may be performed in a distributed manner using cloud computing, various containers, microservices, and other techniques.

As addressed above, safety is an important aspect of the present technology. Whether due to intentional or negligent use of the present technology by a user, or through an unanticipated sequence of prompts, the generative response engine might progress a computing environment towards an undesirable state. Therefore, the present technology can include an additional safety layer that can watch the actions provided by a user and the operator to predict a likely progression towards a future state, and can intervene if the future state is undesirable.

At block 2202, the computing system may be executing the safety model that configures the computing system to receive a first screenshot of a display at a first time from which the safety model can perceive a state of an execution environment at the first time. The computing system may also receive a user-provided-prompt requesting a generative response engine to assist with a task by operating the execution environment and provide a first plurality of screen images to the generative response engine.

The generative response engine perceives a state of the execution environment at the first time from the first plurality of screen images. The computing system may generate instructions to operate the execution environment based on the state of the execution environment at the first time and the user-provided-prompt. For example, the generative response engine operates the execution environment by providing instructions to the operator application, which is configured to receive the instructions and provide synthetic inputs into the execution environment to carry out the instructions. However, in some cases, the computing system may prevent instructions from being executed as further described below.

At block 2204, the computing system may receive, by the safety model, a second screenshot of the display at a second time from which the safety model can perceive the state of the execution environment at the second time. In this example, an operator application has provided synthetic inputs into the execution environment to progress the state of the execution environment from the first time to the second time.

At block 2206, the computing system may predict a future undesirable state of the execution environment at a future time.

At block 2208, the computing system may prevent the operator application from providing additional synthetic inputs that would progress the state of the execution environment toward an undesirable state.

In some cases, the safety model is part of the generative response engine. However, in other cases, the safety model is a separate model from the generative response engine.

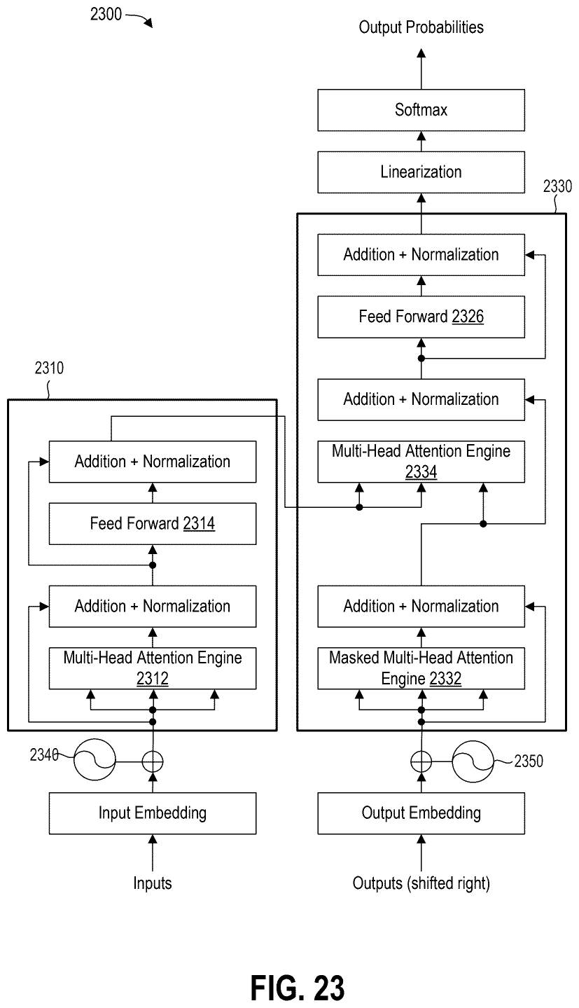

FIG. 23 is a block diagram of an example transformer in accordance with some aspects of the disclosure.

In a convolutional neural network (CNN) model, the number of operations required to relate signals from two arbitrary input or output positions grows in the distance between positions, which makes learning dependencies at different distant positions challenging for a CNN model. Transformer 2300 reduces the operations of learning dependencies by using encoder 2310 and decoder 2330 that implements an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, encoder 2310 is composed of a stack of six identical layers and each layer has two sub-layers. The first sub-layer is multi-head self-attention engine 2312, and the second sub-layer is a fully connected feed-forward network 2314. A residual connection (not shown) connects around each of the sub-layers followed by normalization.

In this example of transformer 2300, decoder 2330 is also composed of a stack of six 6 identical layers. The decoder also includes masked multi-head self-attention engine 2332, multi-head attention engine 2334 over the output of encoder 2310, and fully connected feed-forward network 2326. Each layer includes a residual connection (not shown) around the layer, which is followed by layer normalization. Masked multi-head self-attention engine 2332 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes positional encoder 2340 to encode positions because the model does not contain recurrence and convolution and relative or absolute position of the tokens is needed. In transformer 2300, the positional encodings are added to the input embeddings at the bottom layer of encoder 2310 and decoder 2330. The positional encodings are summed with the embeddings because the positional encodings and embeddings have the same dimensions. A corresponding position decoder 2350 is configured to decode the positions of the embeddings for decoder 2330.

In some aspects, transformer 2300 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. Transformer 2300 can process input sequences of variable length, making it well-suited for natural language processing tasks where input lengths can vary greatly. Additionally, the self-attention mechanism allows transformer 2300 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

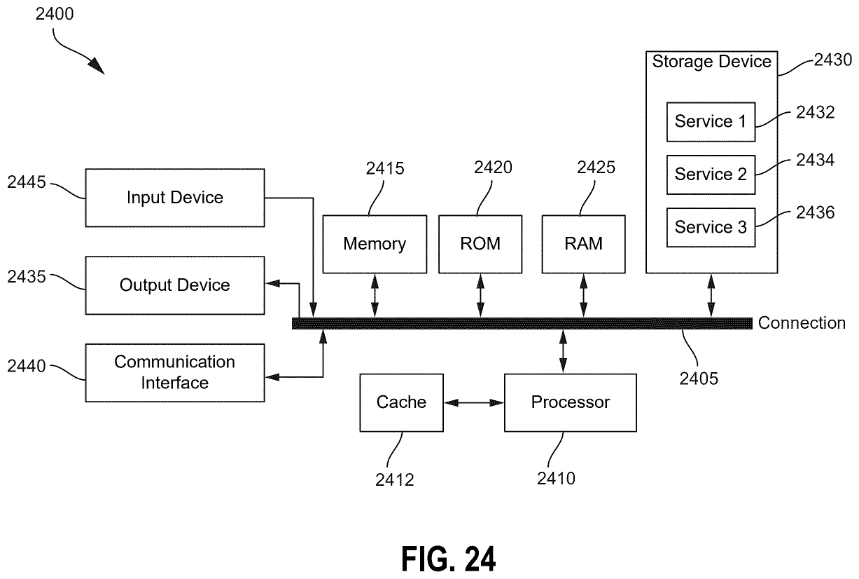

FIG. 24 is a diagram illustrating an example of a system for implementing certain aspects of the present technology. In particular, FIG. 24 illustrates an example of computing system 2400, which can be for example any computing device making up internal computing system, a remote computing system, a camera, or any component thereof in which the components of the system are in communication with each other using connection 2405. Connection 2405 can be a physical connection using a bus, or a direct connection into processor 2410, such as in a chipset architecture. Connection 2405 can also be a virtual connection, networked connection, or logical connection.

In some aspects, computing system 2400 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 2400 includes at least one processing unit (a central processing unit (CPU) or processor) 2410 and connection 2405 that couples various system components including system memory 2415, such as ROM 2420 and RAM 2425 to processor 2410. Computing system 2400 can include a cache 2412 of high-speed memory connected directly with, in close proximity to, or integrated as part of processor 2410.

Processor 2410 can include any general purpose processor and a hardware service or software service, such as services 2432, 2434, and 2436 stored in storage device 2430, configured to control processor 2410 as well as a special-purpose processor where software instructions are incorporated into the actual processor design. Processor 2410 may essentially be a completely self-contained computing system, containing multiple cores or processors, a bus, memory controller, cache, etc. A multi-core processor may be symmetric or asymmetric.

To enable user interaction, computing system 2400 includes an input device 2445, which can represent any number of input mechanisms, such as a microphone for speech, a touch-sensitive screen for gesture or graphical input, keyboard, mouse, motion input, speech, etc. Computing system 2400 can also include output device 2435, which can be one or more of a number of output mechanisms. In some instances, multimodal systems can enable a user to provide multiple types of input/output to communicate with computing system 2400. Computing system 2400 can include communications interface 2440, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 2440 may also include one or more Global Navigation Satellite System (GNSS) receivers or transceivers that are used to determine a location of the computing system 2400 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 2430 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another IC chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 2430 can include software services, servers, services, etc., that when the code that defines such software is executed by the processor 2410, it causes the system to perform a function. In some aspects, a hardware service that performs a particular function can include the software component stored in a computer-readable medium in connection with the necessary hardware components, such as processor 2410, connection 2405, output device 2435, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some examples, the processes described herein (e.g., method 800, method 2000, and/or other process described herein) may be performed by a computing device or apparatus. In one example, the method 800 can be performed by a computing device having a computing architecture of the computing system 2400 shown in FIG. 24.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth™ standard, data according to the IP standard, and/or other types of data.

The components of the computing device can be implemented in circuitry. For example, the components can include and/or can be implemented using electronic circuits or other electronic hardware, which can include one or more programmable electronic circuits (e.g., microprocessors, graphical processing units (GPUs), digital signal processors (DSPs), CPUs, and/or other suitable electronic circuits), and/or can include and/or be implemented using computer software, firmware, or any combination thereof, to perform the various operations described herein.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“&lt;”) and greater than (“&gt;”) symbols or terminology used herein can be replaced with less than or equal to (“≤”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an ASIC, FPGAs, or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. A method comprising: mapping, by an operator application, a window to a process identifier associated with an application that the operator application is at least partially controlling; subscribing, by the operator application, to events generated by the application using the process identifier; receiving, by the operator application, a response from a generative response engine that is responsive to a prompt and describes taking an action in the application; providing, by the operator application, at least one operation to the application based on the response, wherein the at least one operation causes the application to generate at least one event; and in response to determining an event corresponds to a system level event, determining whether to mute the event.

Aspect 2. The method of Aspect 1, wherein determining whether to mute the event comprises: displaying a notification identifying the event based on a rule associated with the event; and permitting the event to be executed based on a user response to the notification.

Aspect 3. The method of any of Aspects 1 to 2, further comprising determining the event corresponds to the system level event is based on a set of rules.

Aspect 4. The method of any of Aspects 1 to 3, wherein a system event monitor is configured to receive the at least one event before passing the event to the application.

Aspect 5. The method of any of Aspects 1 to 4, wherein the system level event affects functionality, performance or security of a device or a network, and a non-system level event affects individual components or users.

Aspect 6. The method of Aspect 5, wherein the system level event includes an immutable file event on a file system.

Aspect 7. The method of any of Aspects 5 to 6, wherein the system level event includes at least one of a process event, an inter-process communication event, a path event, and a file system mount event.

Aspect 8. The method of any of Aspects 1 to 7, wherein determining the event generated based on the subscription comprises identifying whether a source of the event corresponds to the operator application.

Aspect 9. The method of any of Aspects 1 to 8, further comprising determining the event corresponds to the system level event is based on an ML model trained to identify system level events based on a system event interface.

Aspect 10. The method of any of Aspects 1 to 9, wherein determining the event corresponds to the system level event comprises: determining a source of the at least one event is based on user input or a synthetic input or event, wherein the determining whether to mute the event is further based on the source of the at least one event.

Aspect 11. A computing device for performing a function. The computing device includes at least one memory and at least one processor coupled to the at least one memory and configured to: map, by an operator application, a window to a process identifier associated with an application that the operator application is at least partially controlling; subscribe, by the operator application, to events generated by the application using the process identifier; receive, by the operator application, a response from a generative response engine that is responsive to a prompt and describes taking an action in the application; provide, by the operator application, at least one operation to the application based on the response, wherein the at least one operation causes the application to generate at least one event; and in response to determining an event corresponds to a system level event, determine whether to mute the event.

Aspect 12. The computing device of Aspect 11, wherein the at least one processor is configured to: display a notification identifying the event based on a rule associated with the event; and permit the event to be executed based on a user response to the notification.

Aspect 13. The computing device of any of Aspects 11 to 12, wherein the at least one processor is configured to determine the event corresponds to the system level event based on a set of rules.

Aspect 14. The computing device of any of Aspects 11 to 13, wherein a system event monitor is configured to receive the at least one event before passing the event to the application.

Aspect 15. The computing device of any of Aspects 11 to 14, wherein the system level event affects functionality, performance or security of a device or a network, and a non-system level event affects individual components or users.

Aspect 16. The computing device of Aspect 15, wherein the system level event includes an immutable file event on a file system.

Aspect 17. The computing device of any of Aspects 15 to 16, wherein the system level event includes at least one of a process event, an inter-process communication event, a path event, and a file system mount event.

Aspect 18. The computing device of any of Aspects 11 to 17, wherein the at least one processor is configured to: identify whether a source of the event corresponds to the operator application.

Aspect 19. The computing device of any of Aspects 11 to 18, wherein the at least one processor is configured to: determine the event corresponds to the system level event is based on an ML model trained to identify system level events based on a system event interface.

Aspect 20. The computing device of any of Aspects 11 to 19, wherein the at least one processor is configured to: determine a source of the at least one event is based on user input or a synthetic input or event, wherein the determining whether to mute the event is further based on the source of the at least one event.

Aspect 21. A non-transitory computer-readable medium having stored thereon instructions that, when executed by at least one processor, cause the at least one processor to perform operations according to any of Aspects 1 to 10.

Aspect 22. An apparatus for performing a function, comprising one or more means for performing operations according to any of Aspects 1 to 12.

What is claimed is:

1. A method comprising:
mapping, by an operator application, a window to a process identifier associated with an application that the operator application is at least partially controlling;
subscribing, by the operator application, to events generated by the application using the process identifier;
receiving, by the operator application, a response from a generative response engine that is responsive to a prompt and describes taking an action in the application;
providing, by the operator application, at least one operation to the application based on the response, wherein the at least one operation causes the application to generate at least one event; and
in response to determining an event corresponds to a system level event, determining whether to mute the event.

2. The method of claim 1, wherein determining whether to mute the event comprises:
displaying a notification identifying the event based on a rule associated with the event; and
permitting the event to be executed based on a user response to the notification.

3. The method of claim 1, further comprising determining the event corresponds to the system level event is based on a set of rules.

4. The method of claim 1, wherein a system event monitor is configured to receive the at least one event before passing the event to the application.

5. The method of claim 1, wherein the system level event affects functionality, performance or security of a device or a network, and a non-system level event affects individual components or users.

6. The method of claim 5, wherein the system level event includes an immutable file event on a file system.

7. The method of claim 5, wherein the system level event includes at least one of a process event, an inter-process communication event, a path event, and a file system mount event.

8. The method of claim 1, wherein determining the event generated based on the subscription comprises identifying whether a source of the event corresponds to the operator application.

9. The method of claim 1, further comprising determining the event corresponds to the system level event is based on an ML model trained to identify system level events based on a system event interface.

10. The method of claim 1, wherein determining the event corresponds to the system level event comprises:
determining a source of the at least one event is based on user input or a synthetic input or event, wherein the determining whether to mute the event is further based on the source of the at least one event.

11. A computing device for performing a function, comprising:
at least one memory; and
at least one processor coupled to the at least one memory and configured to:
map, by an operator application, a window to a process identifier associated with an application that the operator application is at least partially controlling;
subscribe, by the operator application, to events generated by the application using the process identifier;
receive, by the operator application, a response from a generative response engine that is responsive to a prompt and describes taking an action in the application;
provide, by the operator application, at least one operation to the application based on the response, wherein the at least one operation causes the application to generate at least one event; and
in response to determining an event corresponds to a system level event, determine whether to mute the event.

12. The computing device of claim 11, wherein the at least one processor is configured to:
display a notification identifying the event based on a rule associated with the event; and
permit the event to be executed based on a user response to the notification.

13. The computing device of claim 11, wherein the at least one processor is configured to determining the event corresponds to the system level event based on a set of rules.

14. The computing device of claim 11, wherein a system event monitor is configured to receive the at least one event before passing the event to the application.

15. The computing device of claim 11, wherein the system level event affects functionality, performance or security of a device or a network, and a non-system level event affects individual components or users.

16. The computing device of claim 15, wherein the system level event includes an immutable file event on a file system.

17. The computing device of claim 15, wherein the system level event includes at least one of a process event, an inter-process communication event, a path event, and a file system mount event.

18. The computing device of claim 11, wherein the at least one processor is configured to identify whether a source of the event corresponds to the operator application.

19. The computing device of claim 11, wherein the at least one processor is configured to determine the event corresponds to the system level event based on an ML model trained to identify system level events based on a system event interface.

20. The computing device of claim 11, wherein the at least one processor is configured to:
determine a source of the at least one event is based on user input or a synthetic input or event, wherein the determining whether to mute the event is further based on the source of the at least one event.
